(19) United States
(12) Patent Application Publication
(10) Pub. No.: US 2026/0292564 A1
(43) Pub. Date: Sep. 24, 2026

(54) CSI DETERMINATION AND REPORTING FOR FREQUENCY-DEPENDENT BEAMFORMING

(71) Applicant: InterDigital Patent Holdings, Inc., Wilmington, DE (US)

(72) Inventors: Mohammad Irfan, Chateauguay (CA); Afshin Haghighat, Ile-Bizard (CA); Jonghyun Park, Syosset, NY (US); Loic Canonne-Velasquez, Dorval (CA); Dylan Watts, Montreal (CA); Virgil Comsa, Montreal (CA); Omid Saatlou, Montreal (CA); Moon IL Lee, Melville, NY (US)

(73) Assignee: InterDigital Patent Holdings, Inc., Wilmington, DE (US)

(21) Appl. No.: 19/088,745

(22) Filed: Mar. 24, 2025

(51) Int. Cl. H04W 24/10; H04B 7/06; H04W 72/0453

(52) U.S. Cl. CPC H04W 24/10; H04B 7/0626; H04B 7/0632; H04W 72/0453

(57) ABSTRACT

A method for use in a first wireless transmit/receive unit is described including: receiving configuration information comprising one or more channel measurement resources (CMRs), each of the one or more CMRs being configured with a priority and each of the one or more CMRs or one or more subsets of the one or more CMRs being configured with a selection threshold; receiving and measuring a signal in each of the one or more CMRs; selecting a CMR based on at least one of the measured signal of each of the one or more CMRs, the priority configured for each of the one or more CMRs, or the selection threshold configured for each of the one or more CMRs or for the one or more subsets of the one or more CMRs; and transmitting a report including an identification of the selected CMR and measurement information associated with the selected CMR.

### BACKGROUND

In 5th Generation (5G) New Radio (NR) based systems, the channel measurement resources (CMRs), i.e., the channel-state-information (CSI) reference signal (RS) (CSI-RS) being used for channel measurements may be beamformed, for example, beamformed in analog-domain by the transmitter to direct the measurement resources in a certain angular direction towards the receiver. In some cases, the angular direction used by the transmitter for transmitting the measurement resources may not be accurate relative to the receiver's geographical position, for example, the receiver may not be in the boresight of the beam used for transmission of the CMRs by the transmitter and therefore the CSI measured using the CMRs may not be the best representation of the wireless channel between the transmitter and the receiver.

To address the above issue, the 5G specifications also support hybrid beamforming, where multiple CMRs are transmitted by the transmitter using different analog beamforming weights in a time division multiplexing (TDM) manner. The WTRU may select one or more CMR index(es), also known as CSI-RS index (CRI) and determine a CSI based on each of the selected CMR indexes. Selection of the CMR index(es) or the CRI index(es) is up to the receiver's implementation algorithm.

In the existing CSI framework high CSI reporting latency and channel aging and CMR overhead are required. The existing NR CSI framework is based the WTRU selecting a subset of CMRs and determining a CSI based on the selected subset of CMRs. Due to the time-domain behavior, the CSI reporting latency is high, hence the determined CSI is based on an aged channel. In addition, the WTRU determines a CSI based on a subset of the CMRs, a CMR that is not selected for CSI determination results is a waste, causing unnecessary overhead.

### SUMMARY

In embodiments, a method for use in a first wireless transmit/receive unit (WTRU) comprises: receiving configuration information comprising one or more channel measurement resources (CMRs), each of the one or more CMRs being configured with a priority and each of the one or more CMRs or one or more subsets of the one or more CMRs being configured with a selection threshold; receiving and measuring a signal in each of the one or more CMRs; selecting a CMR based on at least one of the measured signal of each of the one or more CMRs, the priority configured for each of the one or more CMRs, or the selection threshold configured for each of the one or more CMRs or for the one or more subsets of the one or more CMRs; and transmitting a report including an identification of the selected CMR and measurement information associated with the selected CMR. Additionally/alternatively, the method includes wherein the one or more CMRs are one or more channel-state-information reference signal (CSI-RS) resources. Additionally/alternatively, the method includes wherein the measurement information is at least one of CSI, a channel quality indicator (CQI), a rank indicator (RI), a precoding matrix indicator (PMI) or reference signal received power (RSRP). Additionally/alternatively, the method includes creating groups of the one or more CMRs based on frequency domain correlation or spatial correlation between the one or more CMRs. Additionally/alternatively, the method includes determining a common CSI for a group of CMRs from the groups of the one or more CMRs. Additionally/alternatively, the method includes determining a CSI for each CMR in the group of CMRs based on the common CSI. Additionally/alternatively, the method includes wherein each of the one or more CMRs is configured with multiple non-overlapping subbands (SBs). Additionally/alternatively, the method includes wherein each of the multiple non-overlapping SBs is configured with a different spatial filter/beamformer/precoder. Additionally/alternatively, the method includes wherein each of the one or more CMRs is configured with all or a subset of SBs from a bandwidth part (BWP). Additionally/alternatively, the method includes wherein each of the one or more subsets of the one or more CMRs comprises multiple CMRs wherein each CMR in the one or more subsets of the one or more CMRs is associated with one or more SBs.

In embodiments, a WTRU includes: a processor and a transceiver, the processor and transceiver and configured to: receive configuration information comprising one or more channel measurement resources (CMRs), each of the one or more CMRs being configured with a priority and each of the one or more CMRs or one or more subsets of the one or more CMRs being configured with a selection threshold; receive and measure a signal in each of the one or more CMRs; select a CMR based on at least one of the measured signal of each of the one or more CMRs, the priority configured for each of the one or more CMRs, or the selection threshold configured for each of the one or more CMRs or for the one or more subsets of the one or more CMRs; and transmit a report including an identification of the selected CMR and measurement information associated with the selected CMR. Additionally/alternatively, the WTRU includes, wherein the one or more CMRs are one or more channel-state-information reference signal (CSI-RS) resources. Additionally/alternatively, the WTRU includes wherein the measurement information is at least one of CSI, a channel quality indicator (CQI), a rank indicator (RI), a precoding matrix indicator (PMI) or reference signal received power (RSRP). Additionally/alternatively, the processor is further configured to create groups of the one or more CMRs based on frequency domain correlation or spatial correlation between the one or more CMRs. Additionally/alternatively, the processor is further configured to determine a common CSI for a group of CMRs from the groups of the one or more CMRs. Additionally/alternatively, the processor is further configured to determine a CSI for each CMR in the group of CMRs based on the common CSI. Additionally/alternatively, the WTRU includes wherein each of the one or more CMRs is configured with multiple non-overlapping subbands (SBs). Additionally/alternatively, the WTRU includes wherein each of the multiple non-overlapping SBs is configured with a different spatial filter/beamformer/precoder. Additionally/alternatively, the WTRU includes wherein each of the one or more CMRs is configured with all or a subset of SBs from a bandwidth part (BWP). Additionally/alternatively, the WTRU includes wherein each of the one or more subsets of the one or more CMRs comprises multiple CMRs wherein each CMR in the one or more subsets of the one or more CMRs is associated with one or more SBs.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of an example process for determining CSI;

FIG. 3 is a diagram of a further example process for determining CSI;

FIG. 4 is a diagram of a coupling example between CMRs and analog beams;

FIG. 5 is a further diagram of a coupling example between CMRs and analog beams;

FIG. 6 is a diagram of beam hopping for CMR transmission with different analog beams;

FIG. 7 is a diagram of frequency hopping for CMR transmission with different analog beams;

FIG. 8 is a general architecture of an example antenna-panel based on cross polarized antenna elements;

FIG. 9 is an example diagram of two-step CSI determination and reporting;

FIG. 10 is an example timeline associated with two-step CSI reporting;

FIG. 11 is an example of precoder selection for different layers with different CMRs, CMR-Is or CMR-BIs; and

FIG. 12 is a flow diagram of an example process for CSI determination.

### DETAILED DESCRIPTION

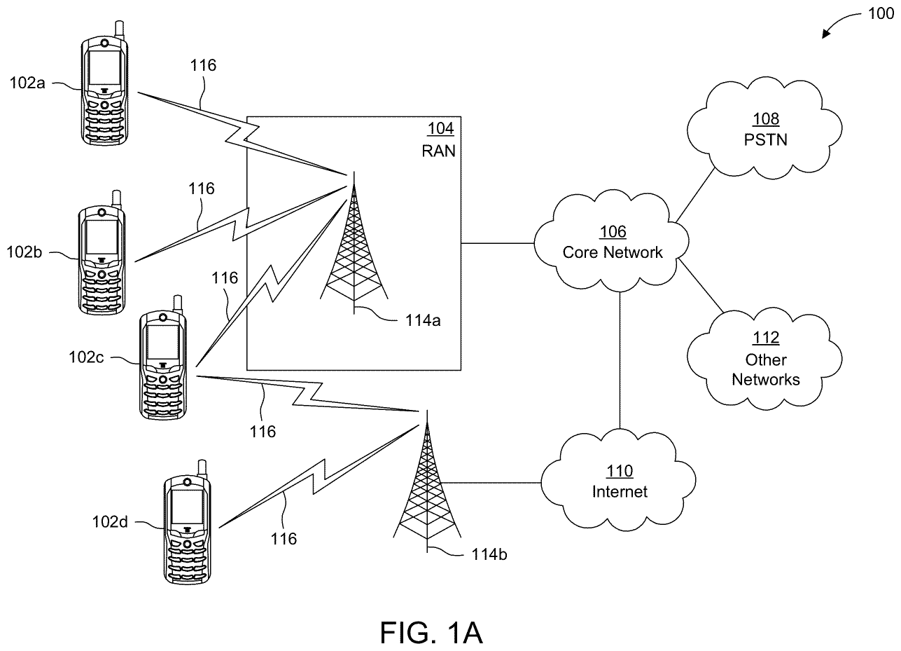

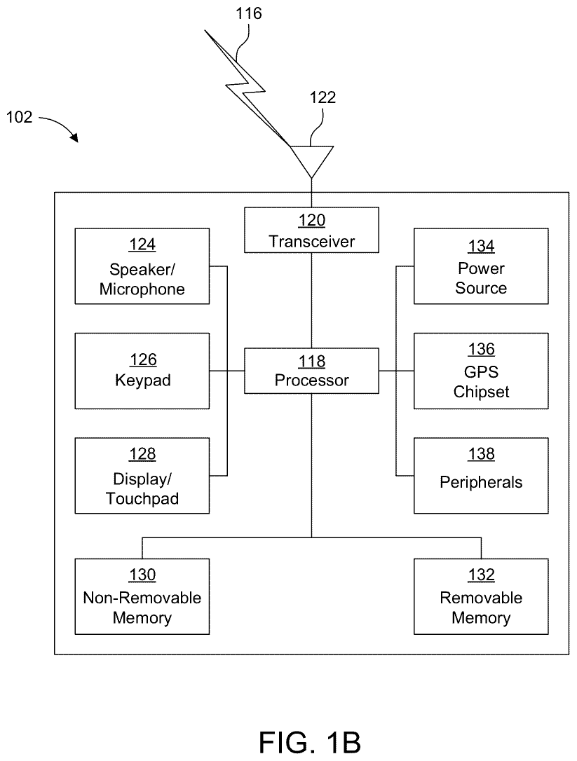

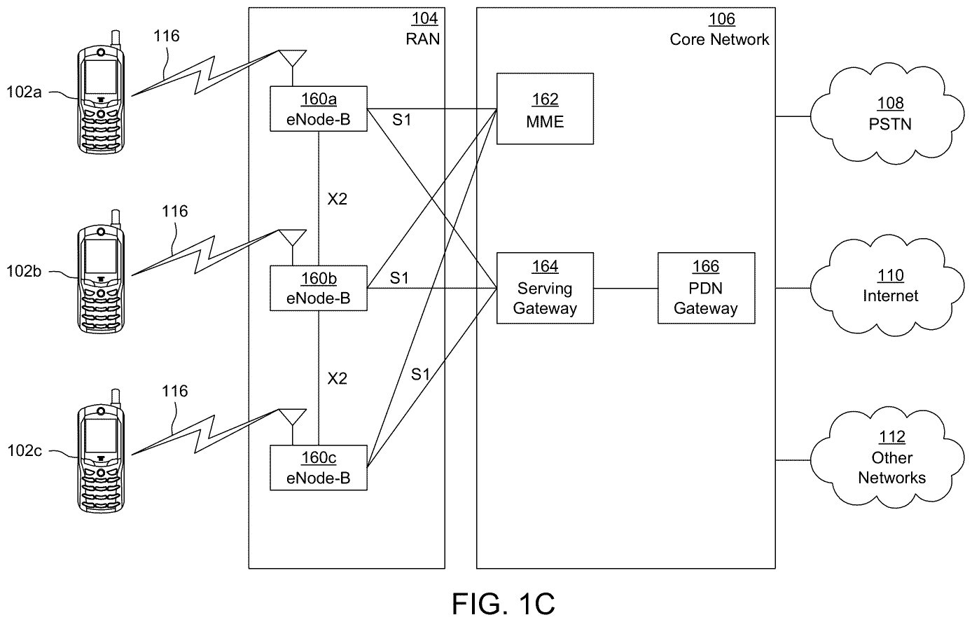

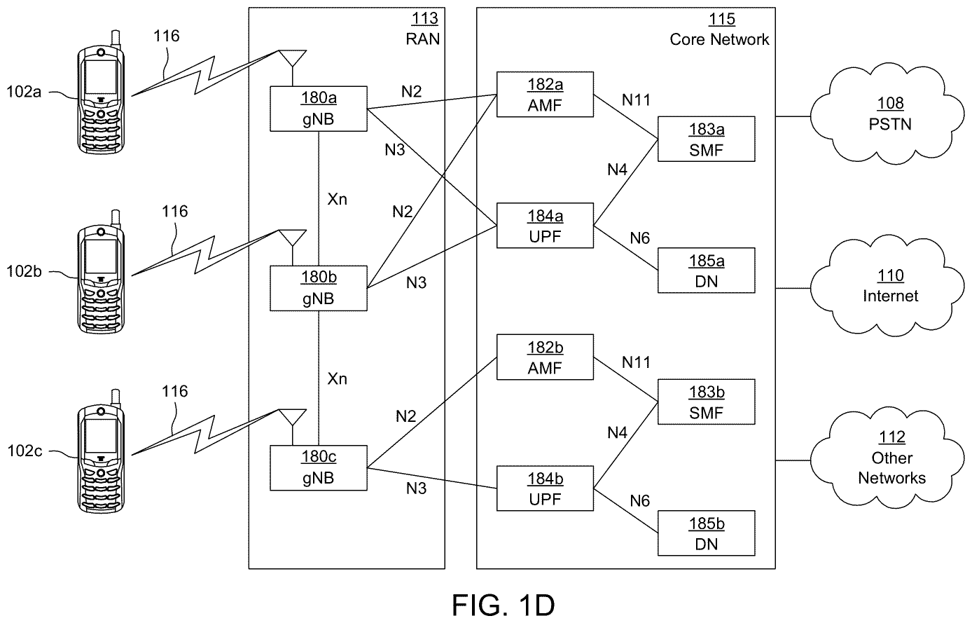

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (for example, radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (for example, an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (for example, for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (for example, WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (for example, the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (for example, the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (for example, multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (for example, a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (for example, nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (for example, longitude and latitude) regarding the current location of the WTRU 102. In addition to, or in lieu of, the information from the GPS chipset 136, the WTRU 102 may receive location information over the air interface 116 from a base station (for example, base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (for example, associated with particular subframes for both the UL (for example, for transmission) and DL (for example, for reception) may be concurrent and/or simultaneous. The full duplex radio may include an interference management unit to reduce and or substantially eliminate self-interference via either hardware (for example, a choke) or signal processing via a processor (for example, a separate processor (not shown) or via processor 118). In an embodiment, the WTRU 102 may include a half-duplex radio for which transmission and reception of some or all of the signals (for example, associated with particular subframes for either the UL (for example, for transmission) or the DL (for example, for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (for example, temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (for example, directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (for example, all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (for example, 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (for example, every STA), including the AP, may sense the primary channel. If the primary channel is sensed/detected and/or determined to be busy by a particular STA, the particular STA may back off. One STA (for example, only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (for example, only support for) certain and/or limited bandwidths. The MTC devices may include a battery with a battery life above a threshold (for example, to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (for example, MTC type devices) that support (for example, only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (for example, containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (for example, such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (for example, handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (for example, testing) wired and/or wireless communication network in order to implement testing of one or more components. The one or more emulation devices may be test equipment. Direct RF coupling and/or wireless communications via RF circuitry (for example, which may include one or more antennas) may be used by the emulation devices to transmit and/or receive data.

Herein, certain embodiments will refer to CMR Case-A and/or CMR Case-B.

Herein, CMR Case-A may refer to a case or the scenario when two or more CMRs are received by a receiver (or transmitted by a transmitter) at the same frequency-unit(s) or at different frequency-unit(s) but at two or more different time-instances. For example, CMR1 is received (or transmitted) at frequency-unit f_1 associated with time symbol 1, CMR2 is received (or transmitted) at frequency-unit f_1 associated with time symbol 2, and CMR3 is received (or transmitted) at frequency-unit f_1 associated with time symbol 3. Each CMR has an associated active window, where the active window associated with two or more CMRs may overlap in zero time instances or more time instances, and where during each active window, the WTRU may use one or more computational-units for determining a CSI based on the CMR. In embodiments, implementation of CMR Case-A may be facilitated or assisted using phase shifter(s) at the transmitter, for example, by analog beamforming the CMRs.

Herein, CMR Case-B may refer to the case or the scenario when two or more CMRs are received by a receiver (or transmitted by a transmitter) at two or more frequency-unit(s) but at the same time-instance. For example, CMR1 is received (or transmitted) at frequency-unit f_1 associated with time symbol 1, CMR2 is received (or transmitted) at frequency-unit f_2 associated with time symbol 1, and CMR3 is received (or transmitted) at frequency-unit f_3 associated with time symbol 3. Each CMR has an associated active window, where the active window associated with two or more CMRs may overlap in zero time instances or more time instances, and where during each active window associated with a CMR, the UE may use one or more computational-units for determining a CSI based on the CMR. In embodiments, implementation of CMR Case-B may be facilitated or assisted using base-band or digital signal processing, digital beamforming, true time delay elements that applies frequency and/or antenna dependent delays to a signal before transmission, and/or joint phase and time array processing.

As noted above, in a CSI framework which is based on CMR Case-A for CSI determination and reporting, there may be higher CSI reporting latency and channel aging and higher CMR overhead. Higher CSI reporting latency and channel aging are noted because in CMR Case-A, where the WTRU may select a subset of CMRs and determine a CSI based on the selected subset of CMRs. Due to the time-domain behavior of the CMR Case-A, the CSI reporting latency is high, hence the determined CSI is based on an aged channel. In addition, there may be higher CMR overhead because the WTRU determines a CSI based on a subset of the CMRs, a CMR that is not selected for CSI determination results is a waste, causing unnecessary overhead.

Embodiments described herein may reduce CSI reporting latency, channel aging, and the higher CMR overhead associated with CMR Case-A, with a new CSI framework based on CMR Case-B. However, several issues may also exist when the CSI determination and reporting is based on CMR Case-B framework, each summarized as follows:

Issues with beam-management or beam selection in CMR Case-B are described. CMR Case-B, the transmitter may be interested in managing the beams, for example, the analog beams used for the CMR transmission, as the transmitter may see multi-user MIMO pairing opportunities in certain beams or interference issues with other beams. In some embodiments, CMR selection based on CMR Case-A is determined by a WTRU's implementation algorithm. However, in other embodiments, the CMR selection based on CMR Case-B may be dictated or assisted both by the gNB and by the WTRU so that the transmitter can properly manage load-balancing, interference management, energy management, etc.

Issues with CSI determination in CMR Case-B are described. The density of the reference signal (RS) (for example, the number of RSs) in CMR Case-B in a given bandwidth for a specific CMR (or beam) may be low as compared to CMR Case-A, because CMR Case-B is based on a frequency-dependent RS or CMR design. For example, at a given bandwidth with two frequency-units, for example, f_1 and f_2 at a given time-unit in CMR Case-A is based on a single beam and in CMR Case-B is based on two beams.

Herein, the term channel measurement resource (CMR) may refer to a reference signal (RS), time-domain resources used for transmission of the RS, frequency-domain resources used for transmission of RS, energy and/or power, for example, energy of the time-domain and/or frequency-domain resources where the RS is transmitted, periodicity of the RS, for example, the RS is repeated every 10 time units, number of antenna ports, for example, logical antenna ports used for transmitting the RS using the time and/or frequency domain resources, number of antenna physical antenna elements used for transmission of the RS using the time and/or frequency domain resources.

Herein, the term CMR index denoted as CMR-I may refer to the index of CMR. For example, a CMR resource set has two CMR. The first CMR has an index 1, denoted as CMR1 and the second CMR has index 2 denoted as CMR2.

Herein, the terms beam pair or CMR beam index denoted as CMR-BI may refer to a CMR and a beam pair, or an association of a CMR and a beam. For example, a CMR is transmitted using a beam, the CMR and the beam relation or the association may be simply expressed as CMR-BI.

Herein, a TRP (for example, transmission and reception point) may be interchangeably used with one or more of TP (transmission point), RP (reception point), RRH (radio remote head), DA (distributed antenna), BS (base station), a sector (of a BS), and a cell (for example, a geographical cell area served by a BS), but still consistent with this invention. Hereafter, Multi-TRP may be interchangeably used with one or more of MTRP, M-TRP, and/or multiple TRPs.

CIS components referred to herein are described. A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (for example, cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or non-zero quantized coefficient, for example, amplitude scaling coefficients and/or phase coefficients.

Herein, a signal or CMR may be interchangeably used with one or more of following terms: Sounding reference signal (SRS), Channel state information-reference signal (CSI-RS), Demodulation reference signal (DM-RS), Phase tracking reference signal (PT-RS), Synchronization signal block (SSB), and/or Tracking reference signal (TRS).

Herein, a channel may be interchangeably used with one or more of following: Physical downlink control channel (PDCCH), Physical downlink shared channel (PDSCH), Physical uplink control channel (PUCCH), Physical uplink shared channel (PUSCH), and/or Physical random-access channel (PRACH).

Herein, a quantity, report quantity, uplink control information (UCI) and/or channel state information (CSI) may be interchangeably used with one or more of following: Rank indicator (RI), Precoding matrix indicator (PMI), Channel quality indicator (CQI), Wideband channel quality indicator (W-CQI), Sub-band channel quality indicator (S-CQI). Wideband precoding matrix indicator (i1). Layer indicator (LI), CSI reference resource index (CRI), Signal to noise and interference ratio (SINR), Reference signal received power (RSRP), and/or Scheduling request.

Herein, downlink transmission or downlink reception may be used interchangeably with Rx occasion, PDCCH, PDSCH, SSB reception, and/or CSI-RS reception.

Herein, uplink transmission or uplink reception may be used interchangeably with Tx occasion, PUCCH, PUSCH, PRACH, and/or SRS transmission.

Herein, the term channel measurement resource (CMR) may be interchangeably used with one or more of CMR resource, CMR resource set, CMR port and/or CMR port group.

Herein, CMR may be interchangeably used with one or more of SSB, CSI-RS, SRS, TRS, PTRS, and/or DM-RS.

In 5G, the layer indicator (LI) is conditioned on CQI, PMI, and RI. The CQI is conditioned on PMI and RI and the PMI is conditioned on RI. In frequency-dependent analog beamforming system, CSI determination for each frequency-unit associated with an analog beamforming is a tedious task in terms of computational complexity and overhead. Therefore, the CSI may be determined based on a subset (for example, based on a subset of frequency-units or a subset of analog beams) channel measurement resources (CMRs), CMR indexes (CMR-Is) or CMR and analog-beam pair (CMR-BIs).

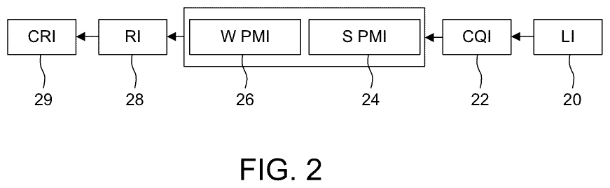

FIG. 2 is an example of the process for determining CRI in a Case-A scenario. In FIG. 2, the following references are used: LI 20, CQI 22, S PMI 24, W PMI 26, RI 26 and CRI 29.

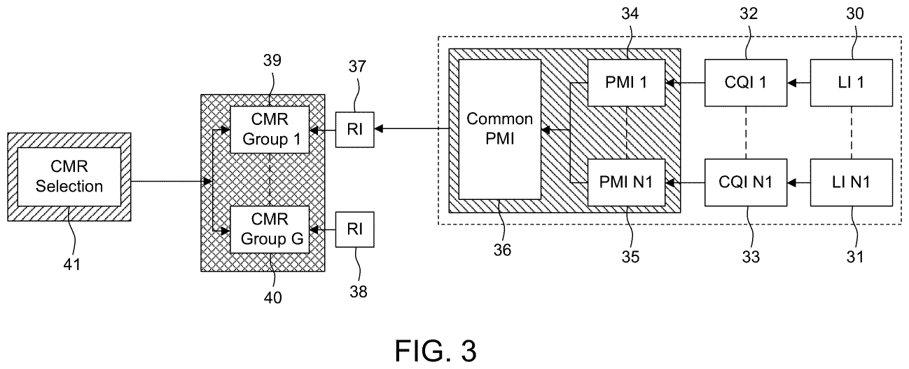

FIG. 3 is an example of a process for determining CRI in a Case-B scenario. In FIG. 3, the following references are used: LI (f_1) 30, CQI (f_1) 32, PMI (f_1) 34, LI (f_n) 31, CQI (f_n) 33, PMI (f_n) 35, common PMI determination 36, RI (Group 1) 37, CMR Group 1 39, and CMR selection 41. For each CMR group, for example, (CMR group 1 to CMR group G), a common RI and a common-PMI is determined and then as explained with the example above, CSI for each CMR, CMR-I, or CMR-BI is determined based on the common-PMI and the common RI value.

As described in embodiments herein in Case-B and shown in the example FIG. 3, a common PMI may be determined based on the group of CMRs and a PMI for PMI. FIG. 3 shows a second group, wherein a second RI 38 and a second CMR for “group G” 40 are determined.

Embodiments described herein may include the following processes, examples of some of which are shown in FIG. 3: CMR selection 41 may include a subset (for example, N) out of the total (for example, M) configured CMRs being first selected. For example, the N selected CMRs are grouped into G=2 groups where the first group has N1 number of CMR, CMR-Is, or CMR-BIs. CMR grouping may include selected CMRs being grouped together for CSI determination. Measurement restrictions and how the WTRU determines a number of uplink resources for CSI determination are described herein. CSI determination and reporting are described and may include a CSI for each CMR being determined based on a common PMI, where the common PMI is determined based on the CMR, CMR-Is, or CMR-BIs in a group of CMRs.

Scheduling frequency resources for downlink transmission in frequency-dependent beamforming systems are also described according to embodiments herein.

Herein, the terms time instance or time-unit may be interchangeably used with slot, sub-slot, symbol, subframe and/or frame.

Herein, the terms frequency instance or frequency-unit may be interchangeably used with subcarrier(s), resource element(s) (RE) s, resource block(s), sub-band(s), band(s), and/or bandwidth part(s).

Herein, the terms, transmitter, receiver, base station, gNB, UE, and WTRU may be interchangeably used.

Herein, the term “antenna unit” may refer to a physical antenna element or a logical antenna port.

Herein, the term CSI report may refer to one or more indications sent using the uplink channel or resources. The indications may be partitioned into one or more parts or groups. For example, a two parts CSI reports. CSI part 1 may refer to the first part of a CSI report. CSI part 2 may refer to the second part of a CSI report. CSI part 1 may include indications that indicates the payload size carried by CSI part 2. For example, CSI-part 1 includes indications for the rank value (RI) and the number of NZ coefficients. For example, CSI-part 2 includes indication for precoders (for example, PMI), NZ coefficients and other parameters, for example, CQI, wideband CQI, sub-band CQI etc.

Herein, the terms CMR, CMR-Is, or CMR-BIs may be interchangeably used with frequency-unit, sub-band, BWP and/or RB.

Herein, the term report quantity or quantity may refer to one or more of the following, wideband PMI, Sub-band PMI, wideband CQI, sub-band CQI, differential sub-band CQI, LI, RI, CSI-RS resource index (CRI), first number of non-zero coefficient, where a non-zero coefficient may be an amplitude scaling factor or a phase coefficient for sub-band(s) and/or wideband. The number of CSI-RS antenna ports, DFT-oversampling value, codebook modes, for example, mode-1 or mode-2, codebook type, for example, Type-I codebook, Type-II codebook, enhanced Type-II codebook, number of panels, for example, single panel or multi-panel, Number of codewords, for example, 1 codeword per panel, number of TRPs, and/or number of sub-bands.

Embodiments for channel measurement resource selection are described in the following section herein.

Capabilities and support for CMR selection are described. In embodiments, a WTRU may be provided with one or more configuration(s) for to support channel measurement resource (CMR) selection and reporting. In embodiments, CMR selection may (for example, additionally) only be initiated if supported by both the WTRU and network (NW). A WTRU may indicate capability for one or more aspects of the CMR selection for example, prior to initiation of the procedure or reception of associated configurations. A NW may indicate support (for example, per cell) for one or more aspects of the CMR selection. A WTRU may, for example, only initiate a procedure and/or expect configuration with a cell(s) which support the procedure.

In embodiments indication of WTRU capability, NW support, and the reception of one or more configurations to support CMR selection and reporting are supported.

In embodiments, a capability may be required for CMR selection. The capability may be related to all aspects of the CMR selection and reporting or one or more aspects. Support for CMR selection may be reported by the WTRU and/or indicated by the network (for example, on a cell-specific basis).

A WTRU may indicate capability and/or support for one or more aspects of CMR selection. In embodiments, the WTRU may indicate a single capability to indicate support for all aspects of CMR selection. In other embodiments, the WTRU may report support for an/each aspect of CMR selection. For example, the WTRU may indicate support for one or more of the following: a) Measurement based CMR selection; b) Priority based CMR selection; c) Joint measurement/priority-based CMR selection; and/or d) Maximum size of the CMR subset.

In embodiments, a WTRU may report the capability of one or more of the above aspects of CMR selection, for example, via the WTRU capability transfer procedure. In another example the WTRU may indicate capability and/or support via one or more of the following methods: a) random access (or use of one or more dedicated resources, use of random access preamble partitioning for example, a set of reserved preambles or random access occasions, RNTIs; b) upon RRC connection establishment/resumption for example, Msg3 or Msg5; c) upon request from the network (for example, upon reception of the capability enquiry message); and/or d) WTRU assistance information.

In embodiments, capability to support/perform/execute/initiate one or more aspects of CMR selection and reporting may be reliant/linked to one or more other configurations. For example, the network may assume that a WTRU is capable of one or more aspects of CMR selection based on, for example, the activation, state, and/or configuration of one or more of the following: a) SB-level CMR configuration; and b) CMR priorities.

In embodiments, the capability and/or support for initiation of one or more aspects of CMR selection may be reliant on one or more characteristics of the WTRU. For example, one or more of the following: a) WTRU speed; b) Remaining WTRU power; c) processing ability; d) WTRU location for example within a certain set of cells, using one of a set of specific beams, GPS location; and/or e) when a particular type of service is in use, for example related to one or more specific network slices or QCIs.

In cases where a WTRU is configured for CMR selection and reporting, and an associated configuration is not present and/or active and/or the WTRU characteristics are not suitable, it may be assumed that the procedure is temporarily disabled (for example, the WTRU may not initiate the procedure) or inactive. The WTRU may indicate (for example, subject to configuration) to the network that CMR selection is temporarily inactive for example, via a MAC CE, UCI or RRC signaling. In some embodiments, the WTRU may also report the reason for why the procedure is inactive (for example, a joint configuration is disabled, or the WTRU characteristics are not suitable).

Network support for CMR selection and reporting are described herein.

In embodiments, the network may indicate support for CMR selection. Support for CMR selection may be, for example, per cell, per PLMN, per frequency, per tracking area (TA) or RAN notification area (RNA). The indication may be, for example, a flag and/or bit in system information which indicates support for CMR selection and reporting. In another example, the NW may indicate support for an aspect of the procedure (for example, that the cell supports CMR selection, but not reporting aspects). In another embodiment, the network may indicate (for example, within system information and/or via RRC configuration) a list of one or more cell(s) which support CMR selection. In embodiments, the WTRU may only initiate CMR selection or one or more aspects of CMR selection subject to the network supporting the procedure. For example, the WTRU may only resume CMR selection upon return to RRC connected if the cell has indicated support for CMR selection.

Details of embodiments are described herein for configuration of a WTRU with CMR resources. In embodiments, a WTRU may receive configuration of one or more channel measurement resources (CMR) (for example, CSI-RS resources) where each CMR is configured with a selection priority and one or more subsets (for example, pairs) of the CMRs are configured with a selection threshold.

In embodiments, a WTRU may be configured with one or more channel measurement resources (CMR) within a CMR resource set. A CMR may comprise a RS such as a CSI-RS and may be configured per bandwidth part (BWP). The WTRU determines the bandwidth of a CMR within a BWP based on RRC configured parameters which indicate the RB indices where the CMRs are transmitted (for example, a starting position and number of RBs). The RB configuration determines the frequency domain location of resource elements (REs) that contain CMR signals for a given symbol/slot in time. A subband (SB) comprises a group of consecutive RB indices. Each CMR may be associated with an index (for example, for CSI-RS, each CMR is associated with a CSI-RS Resource Indicator (CRI).

In embodiments a WTRU may be configured to measure one or more CRIs. In a system configured for SB-level CSI, the CMR may be configured in one of the following two options.

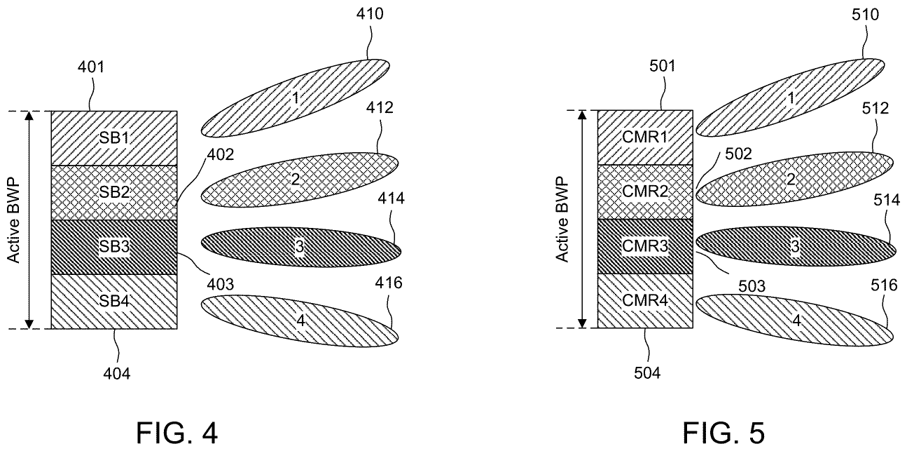

In embodiments termed CMR measurement Option 1, an example of which is shown in FIG. 4, the WTRU determines that each CMR is configured with multiple non-overlapping SBs. Each of the SBs may be configured with a different spatial filter/beamformer/precoder (for example, analog or digital) 410, 412, 414, 416. The CMR may be configured with all or a subset of SBs from the BWP.

In embodiments termed CMR measurement Option 2, an example of which is shown in FIG. 5, the CMR resource sets comprises multiple CMRs each CMR is associated to one or more SBs 510, 512, 514, 516. In embodiments There may be a one-to-one association between each CMR index and a SB. Alternatively, one or more SBs may be associated to each CMR. The SBs may be disjoint or shared between different CMRs, where sharing means that one SB index is associated with more than one CMR.

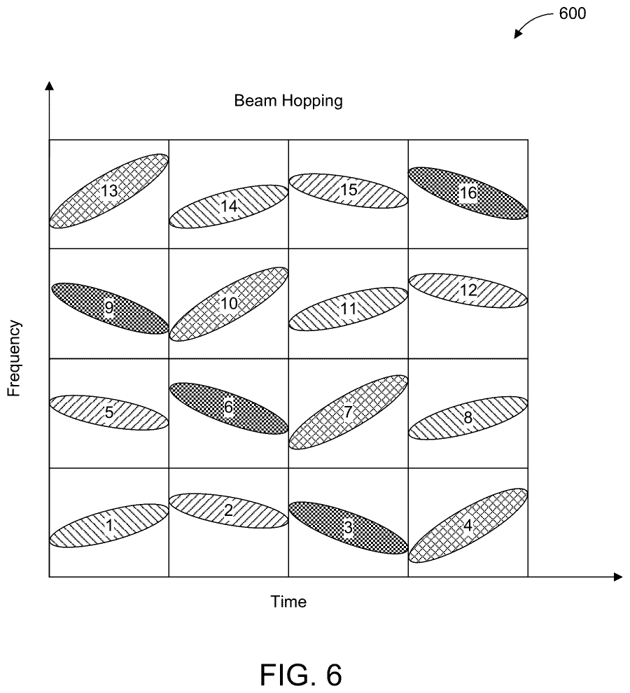

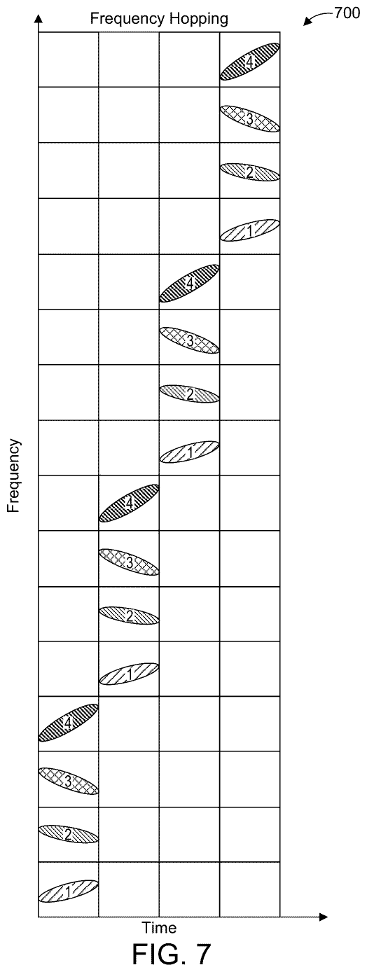

In embodiments, a CMR may be configured with multiple symbols/slots in time where each pair of SB and symbol/slot index is configured with a different beam/spatial filter/beamformer/precoder. This case may be defined as a SB-level spatial hopping where the WTRU may determine the spatial filter/beamformer/precoder of a CMR as a function of the symbol/slot and SB index. FIG. 7 is an example illustrating one such configuration 700 with four different beams. FIG. 6 is an example configuration 600, wherein the WTRU may receive a CMR over multiple time/frequency locations which are here numbered from 1-16. Each time/frequency location corresponds to a pair of symbol/slot and SB index and is configured with a different beam represented by the design within each beam depiction. In embodiments, such a configuration may allow the NW to transmit all its beams over all the SBs using a single CMR (for example, Option 1), or transmit a subset of beams over a subset of SBs (for example, Option 2).

In embodiments, a WTRU may be configured with one or more CMR (for example, CSI-RS) resources transmitted over a configured bandwidth for CSI measurement, where each configured CMR may support P antenna units, for example, CSI-RS antenna ports. Further, the configured CMRs may be associated with one or more analog beams, for example, M beams. For example, a WTRU may be configured with M transmission configuration indicators (TCIs) for the configured CMRs. In embodiments, a WTRU may perform CSI computation and report based on the configured CMRs. In embodiments, a WTRU may report more than one CSI, where each CSI may be based on a different analog beam hypothesis, for example, M hypotheses. A WTRU may also receive CSI reporting resources corresponding to N CSI reports, where N≤M.

FIGS. 4 and 5 show two different options for configuration of CMRs, where in each case, M=4 analog beams, which may be associated with the configured CMRs. In embodiments, one or more of the following options may be used.

In embodiments, collectively termed here CMR measurement Option 1, a WTRU may be configured with a single CMR resource with a first value of density, for example, d1, for mapping of CMRs. In an example, a configured density d1=1 means that every RB contains the configured P antenna unit CSI measurement resource CMR. For a configured M number of analog beams, a WTRU determines a second density, d2, using d1 and M configured values. For example, a WTRU may determine d2, as the density corresponding to each analog beam, by d2=d1/M, or, d2=[(d1/M)]. Therefore, in an embodiment, every RB or a configured number of RBs, for example, subbands, may be associated with a different analog beam.

As shown in the example in FIG. 4, a single CMR 400 with a density of d1=1 is configured. Further, subband size and M are configured as SB=1 RB and M=4. The density d2 is determined as d2=¼, therefore every of M=4 analog beams 410, 412, 414, 416, may be repeated every 4 RBs.

In further embodiments, collectively termed here CMR measurement Option 2, a WTRU may be configured with a single CMR set with M CMRs in the set. The CMR are configured with a specific offset value so that the WTRU may create a contiguous band from CSI transmission perspective. The density of CMR transmission for each configured CMR may be defined as d=1/M. In an embodiment, every RB or a configured number of RBs, for example, subbands, may be associated with a different analog beam. In case of subbands with more than 1 RB, the WTRU may receive a repetition factor M1, by which RBs correspond to a same analog beam may be M1 times repeated in frequency domain, where each repetition may contain a same resource mapping pattern and number of ports. Similar to CMR measurement Option 1, a WTRU may determine a second density, d2, as the density corresponding to each analog beam, by d2=d1/M, or, d2=[(d1/M)]. Therefore, in an embodiment, every RB or a configured number of RBs, for example, subbands, may be associated with a different analog beam.

FIG. 5 is an example illustrating CMR measurement Option 2 with 4 CMRs is configured. Further, subband size and M are configured as SB=1 RB, i.e., M=4 The density d2 is determined as d2=¼, therefore every of M=4 analog beams, may be repeated every 4 RBs.

Each duplet of CSI-RS resource and an analog beam may be identified by an index, for example, CMR-Beam indicator (CMR-BI) or CMR index (CMR-I), that may represent the CMR resource and its associated analog beam. Therefore, a same CSI resource may be associated with more than one CRB-Is depending on the analog beam associated with it. Similarly, a same analog beam may be associated with more than one CMR-BIs or CMR-Is depending on the CMR resource associated with it. When a WTRU reports CSI for a CMR-BI or CMR-I, the reported CSI is representative of the observed channel and an analog beam at a particular part of channel. Therefore, to ensure an accurate acquisition of a channel, as shown in, analog beam hopping or frequency hopping may be employed, where a channel may be sounded with different M analog beams.

FIGS. 6 and 7 show example cases of analog beam hopping (FIG. 6) and frequency hopping (FIG. 7) mechanisms. In the example of analog beam hopping (FIG. 6, 600), a WTRU receives 16 CMR-BIs, where each CMR-BI identifies the CMR resource and its associated analog beam. In the case of analog beam hopping, each CMR resource is transmitted by a different analog beam to allow the WTRU to determine the best combination of frequency resource and analog beams. In the example of frequency hopping (FIG. 7, 700), a same combination CMR and beams are assumed, for example, 4 CMR-BIs, where each duplet may be mapped at a different frequency and time resource.

In embodiments, for each CMR-BI, a WTRU may receive an additional configuration parameter as a selection priority indicator. The selection priority indicator may be used when reporting of corresponding CSI for each resource associated with a CMR-BI. The indicator, may be used in determining whether a CSI may be dropped, or reported late, etc. For example, when a WTRU receives the CMRs for reporting a CSI, the WTRU may use the configured selection priority values to select the N CMRs for reporting of CSI. The selection priority parameter may have additional sub-parameter to indicate whether the selection priority indicator is applicable to the duplet of CMR-BI, i.e., the CMR and beam pair, the CMR index, for example, the CMR-I or the analog beam.

In embodiments, a WTRU may receive a configuration to prioritize reporting of the CSI for a specific analog beam. For example, a WTRU may receive a configuration that prioritize CSI reporting for CMR-BIs={4, 7, 10, 13} that are all associated with a same analog beam for CMR transmission. Such configuration is effectively, prioritizing determination of the best frequency resource using a same corresponding beam. Alternatively, a WTRU may receive a configuration that prioritize CSI reporting for CMR-BIs={1, 2, 3, 4} that are all associated with the same frequency resource for CMR transmission. In this case, the purpose of the configuration is to prioritize determination of the best analog beam for transmission of CMR at a given frequency resource.

In embodiments a Channel Measurement Resource Index (CMR-I) is defined to comprise of a pair of contiguous time (for example, slot, symbol, frame) and frequency (for example, RE, subcarrier, RB, SB) indices which are associated with the same beam (for example, spatial filter/beamformer/precoder). For example, in FIGS. 6 and 7, each numbered item represents a CMR index. Each CMR-I may comprise multiple time/frequency indices (for example, multiple SBs and multiple slots). If repetition is configured, a WTRU may expect to receive multiple CMR-Is with the same configuration over several resources (for example, in time and/or frequency), and each CMR-I may be associated with a repetition index.

In embodiments, the terms selection priority and selection threshold may be used as follows. Each CMR/CRI/CMR-I may be configured with a selection priority index such that the WTRU may determine that some resources have higher priority than others. For example, a WTRU may determine that CMRs are associated with a selection priority 0 or 1, and the WTRU determines that resources associated with selection priority 0 have lower priority than resources associated with selection priority 1. The selection priorities for one or more CMRs may be semi-statically or dynamically (for example, by RRC, MAC-CE, and/or DCI) configured and/or indicated.

In embodiments, one or more of the configured CMRs, for example, one or more of the configured M CMRs may be configured with a selection threshold, for example, with an RSRP or SINR threshold. The thresholds for one or more of the CMRs may be dynamically or semi-statically (for example, by RRC, MAC-CE, and/or DCI) configured or indicated to the WTRU. For example, a CMR is RRC configured. The CMR is associated with an RRC configured information element, for example, a CMR threshold that indicates the threshold for the CMR. A pair of CMRs/CRIs/CMR-Is may comprise two or more indices that may be associated together into subsets, and each subset may be semi-statically or dynamically (for example, by RRC, MAC-CE, and/or DCI) configured with a selection threshold, for example, an RSRP or SINR threshold. For example, CMRs may be configured in the form of a resource set. Multiple threshold values may be RRC configured. The CSI request field may have an associated indication that indicates the selection threshold value for the set of CMRs. For example, the DCI includes a CSI request field that indicates indexes of one or more CMR resources. The CSI request field has an associated field that indicates an RRC configured threshold value or dynamically indicated threshold value for the CMRs associated with the CSI request.

In embodiments, described below, methods to (re) acquire, adapt, or release configurations for CMR selection and reporting may be necessary to ensure a WTRU may continue to maintain related configurations for CMR selection and reporting.

In embodiments, the WTRU may be provided with configurations for CMR selection and reporting upon establishment/resumption of an RRC connection (for example, within the RRC Setup/Resume message) or upon handover to another cell (for example, within a HO command/RRC reconfiguration message with a reconfiguration with sync) or at any time during an active RRC connection (for example, RRC reconfiguration message without reconfiguration with sync). In some other embodiments, configurations for CMR selection may be indicated/configured/provided via one or more of the following signaling methods: SIB (for example, a new SI block, or within another existing SIB), NAS, MAC CE, DCI, RACH (for example, MSG2, MSG4, MSGB), RRC, and/or PDCCH/PUSCH.

In embodiments, the WTRU may receive different information and/or components of a configuration for CMR selection via different signaling methods. For example, the WTRU may receive some dedicated configuration aspects via RRC signaling (for example, SB-level CMR configurations), and some other configurations or information via system information (for example, CMR priorities) If a WTRU is provided with a dedicated configuration/indication related to CMR selection, the WTRU may override other common configuration information (for example, received via broadcast signaling) or may combine the dedicated configuration with one or more pieces of common configuration information. In another example, the WTRU may use the most recently received information in the configuration regardless of the signaling method.

In embodiments, the WTRU may receive one or more alternative configurations using one signaling method (for example, via system information or dedicated RRC signaling). Using another type of signaling (for example, via dedicated RRC signaling or MAC CE) the network may select or indication which of the one or more alternative configurations to apply.

In embodiments, the WTRU may receive a configuration based on NW decision (for example, upon release to RRC IDLE or RRC INACTIVE) for example, if the WTRU indicates it is capable of CMR selection. In further embodiments, the WTRU may request to be configured CMR selection.

In embodiments, a WTRU may request configuration(s) for CMR selection, update existing configuration(s) for CMR selection, and/or apply different configuration(s) for CMR selection. The WTRU may release related configurations for CMR selection (for example, all or one or more parts of a configuration), for example, if the current serving cell does not support CMR selection and/or reporting.

In embodiments, a WTRU may adapt (for example, change) one or more aspects of configuration(s) for CMR selection based on the WTRU characteristics. Examples of WTRU characteristics may include: a) WTRU speed and/or position; b) WTRU power and/or battery level; and c) WTRU processing capability and/or load.

Upon detection of change in WTRU characteristics, the WTRU may modify one or more aspects of the current configuration and/or apply a new configuration. The way that the WTRU detects which aspects of the configuration to change may be based on conditions associated with the configuration and/or aspect(s) of the configuration. For example, the WTRU may be provided with one or more threshold(s), wherein if a threshold is exceeded (or if a value has fallen below a threshold) the WTRU will apply an alternative configuration and/or value for the same configuration.

CMR and CMR-I selection are described herein.

For a subset of CMRs, the WTRU receives and measures a signal (for example, CSI-RS) in each CMR of the subset and selects a CMR from the subset based on the measurements, the selection priority configured for each CMR in the subset and the selection threshold configured for the subset.

For example: A first CMR (CMR1) in the subset has a first priority and a second CMR (CMR2) in the subset has a second priority that is lower than the first priority. A first measurement (for example, RSRP) using CMR1 is a first value (Meas1) and a second measurement (for example, RSRP) using CMR2 is a second value (Meas2) and the selection threshold is PriThresh. The WTRU then selects CMR1 vs CMR2 based on one or more of the following (for example, when Meas2 is greater than Meas1): a) If Meas1 and Meas2 are both greater than PriThresh, the WTRU selects CMR1; b) If the difference between Meas1 and Meas 2 is less than PriThresh, the WTRU selects CMR1; c) If Meas2 is more than PriThresh greater than Meas1, the WTRU selects CMR2.

In CMR Case-B, the transmitter may be interested in the CSI associated with some beams or CMRs as compared to the CSI associated with beams or CMRs due to multiple reasons, for example, due to load balancing, multi-user pairing, and/or interference management etc. In NR, the selection of a CMR is up to the WTRU's implementation algorithm. However, to properly manage the beams, a method may be specified in the specifications of future wireless communication networks to properly manage the beams in CMR Case-B. The method of such CMR selection may be based on beam-specific inputs provided by the gNB and WTRU-specific or a group of WTRU's specific measurements (for example, RSRP, or SINR) performed by the WTRU and/or other WTRU's situations and conditions of the WTRU, for example, available measurement and processing resources at the WTRU, available power or energy at the WTRU.

In embodiments, a WTRU may select an SSB beam index “i” when it camps on a cell of a base station. Under the coverage of the SSB beam index i, the base station may support a few analog beams and their associated sub-bands that may be a sub-set of the total analog beams and sub-bands. As a subset of analog beams may be QCL-ed with the SSB beam index i, selected by the WTRU the base station may configure the CMRs for further down selection of an analog beam or a sub-set of analog beams.

For example, the SSB index i may have a sub-set of 3 analog beams under its coverage, and thus the base station may configure M=3 CMR resources on 3 sub-bands with priorities High, Medium, or Low that may be based on one or any combination of the following criteria: a) cell load per subband; b) initial sub-band CQI reported by the WTRU based on a wideband CMR; and/or c) initial sub-band reported PMI.

Alternatively, more than one SSB index may be reported by the WTRU. In this case, the WTRU may be configured with a wider range of analog beams associated resources that may be time multiplexed, for example, CMR configured based on CMR Case-A. In this case, the WTRU may structure the CMR reporting per SSB association, or as list best on a selection based on a reporting threshold or a threshold with a hysteresis (for example as an as an interval in dB: better than “X” and no less than “X−3 dB”). For example: a) all analog beams that are better than a threshold, or b) all analog beams that are better than “X” and no less than “X−3 dB”).

Upon receiving CMR configuration, the WTRU may measure all indicated CMRs and may report the quality of the analog beams. The measurements of the indicated resources may be one or a combination of any of the following quantities: a) RSRP and/or differential RSRP between the measured CMRs; b) L1-SINR and or differential L1-SINR between the measured CMRs; and/or c) CQI, for example, sub-band CQI.

Selection priority values and threshold values are described herein.

In embodiments, the WTRU may semi-statically or dynamically (for example, by RRC, MAC-CE, and/or DCI) receive, for example, explicitly or implicitly receive one or more of the following,
a) the CMRs associated with one or more beams, for example, the WTRU receives N number of CMRs where one or more CMRs is transmitted using a different beam, for example, the N CMRs are associated with N different beams;
b) a selection priority value associated with one or more CMRs, for example, 1) the selection priority value is defined using a numerical number, for example, the selection priority value takes values in the range 0 to 1, where the selection priority value 0 may be considered a high selection priority, selection priority value 0.5 may be considered a medium selection priority, and selection priority value 1 may be considered a low priority or alternatively, the selection priority value 1 may be considered a high selection priority, the selection priority value 0.5 may be considered a medium selection priority and a selection priority value 0 may be considered a low selection priority. 2) Alternatively, the selection priority values may be defined in the range 0 to 10, where selection priority value 0 may be considered a high selection priority, selection priority value 5 may be considered a medium selection priority, and selection priority value 10 may be considered a low selection priority or alternatively, the selection priority value 10 may be considered a high selection priority, the selection priority value 5 may be considered a medium selection priority and a selection priority value 0 may be considered a low selection priority.
c) a selection threshold or a selection threshold value, for example, RSRP threshold value or SINR threshold value associated with one or more CMRs, for example: 1) for a first CMR associated with a first beam, the RSRP threshold value is 2 dB; 2) for a second CMR associated with a second beam, the RSRP threshold value is 5 dB; 3) for a third and fourth CMRs that are associated with a third beam, the RSRP threshold value is 10 dB; 4) one or more CMRs may be associated with a CMR set and the selection threshold value or the threshold value may be CMR set specific; or 5) one or more CMRs may be associated with a CMR set and the selection threshold value or the threshold value may be CMR specific, for example, one or more CMRs in the CMR set may have an associated selection threshold value or threshold value.

In embodiments, a WTRU may decide to select or not to select a CMR or a beam associated with a CMR based on one or more of the following: a) the selection priority value associated with the CMR or the selection priority value associated with a beam of the CMR; b) the selection threshold value or the threshold value associated with a CMR or the selection threshold value or threshold value associated with the beam of the CMR; and/or c) the measurements, for example, RSRP or SINR performed based on a CMR or performed based on a beam associated with a CMR.

The selection threshold value or the threshold value and the measured RSRP or SINR considered in the examples are based on linear values not decibel values.

In embodiments, a WTRU may use selection priority values associated with the configured CMRs for selection of the CMRs and/or the measurements (for example, RSRP or SINR) performed by the WTRU based on the configured CMRs, when at least one of the following is satisfied: a) The measurements, for example, the RSRP or the SINR measurements performed by the WTRU based on one or more CMRs is equal to or less than a pre-configured threshold value. b) The measurements, for example, the RSRP or the SINR measurements performed by the WTRU based on one or more CMRs is equal to more than a pre-configured threshold value. c) The CMR priorities, when the measurements performed by the WTRU based on one or more CMRs is equal to or less than a pre-configured threshold values. d) The CMR priorities, when the measurements performed by the WTRU based on one or more CMRs is equal to or more than a pre-configured threshold values. e) The CMR priorities are used for selection of the CMRs resources when the actual measurements performed by the WTRU are less than (or alternatively greater than) or equal to a first threshold and the actual measurements are used for selection of the CMR resources when the actual measurements performed by the WTRU are more than (or alternatively less than) or equal to a second threshold. f) The CMR priorities are used for selection of the CMRs resources when the actual measurements performed by the WTRU are within a first window of RSRP or SINR values and the actual measurements are used for selection of the CMR resources when the actual measurements performed by the WTRU are within a second window of RSRP or SINR values. g) The CMR priorities are used for selection of the CMRs resources when the difference (for example, the absolute difference) of the measurements performed by the WTRU on two or more CMRs are less than (or alternatively greater than) or equal to a first threshold and the actual measurements are used for selection of the CMR resources when the difference (for example, the absolute difference) of the measurements performed by the WTRU one two or more CMRs are greater than (or alternatively less than) or equal to a second threshold value.

Hereinafter, explicit examples are shown to demonstrate embodiments of CMR selection or beam selection. The total number of configured CMRs are be denoted by M and the total number of CMRs that the WTRU wants to select will be denoted by N, where 0≤N≤M.

TABLE 1

| | Measured RSRP/SINR | | | | | | |
|---|---|---|---|---|---|---|---|
| | CMR1 | CMR2 | CMR3 | Absolute difference between | | | |
| Selection | High | Medium | Low | [CMR1, | [CMR1, | [CMR2, | Selected |
| example | priority | priority | priority | CMR2] | CMR3] | CMR3] | CMR |
| 1 | 1 | 2 | 3 | 1 | 2 | 1 | CMR1 |
| 2 | 2 | 6 | 6 | 4 | 4 | 0 | CMR2 |
| 3 | 2 | 2 | 6 | 0 | 4 | 4 | CMR3 |

The example in Table 1, is based on a gNB configuration that includes M=3 CMRs and N=1 CMR with an associated high selection priority for CMR 1, a medium selection priority for CMR2 and a low selection priority for CMR3. A selection threshold value or a threshold value of 3 is considered. Three selection examples are depicted in Table 1.

In selection example 1, the measurements (for example, RSRP or SINR) based on CMR1, CMR2, and CMR3 is 1, 2, and 3 respectively. The absolute difference between CMR1 and CMR2 is 1, the absolute difference between CMR1 and CMR3 is 2, and the absolute difference between CMR2 and CMR3 is 1. Since the absolute difference for all the cases is less than 3, so for selection of CMR, the WTRU follows the priorities of the CMR. Therefore, the WTRU selects a CMR with the highest selection priority, which is the first CMR, i.e., CMR1.

In selection example 2, the measurements (for example, RSRP or SINR) based on CMR1, CMR2, and CMR3 is 2, 6, and 6 respectively. The absolute difference between CMR1 and CMR2 is 4, the absolute difference between CMR1 and CMR3 is 4, and the absolute difference between CMR2 and CMR3 is 0. Since the absolute difference between CMR1 and CMR2 is more than 3, and the absolute difference between CMR1 and CMR3 is also more than 3, the WTRU may select CMR2 as it has the same measurement value as CMR3 but CMR2 has higher selection priority as compared to CMR3. Therefore, CMR2 is the selected CMR.

In selection example 3, the measurements (for example, RSRP or SINR) based on CMR1, CMR2, and CMR3 is 2, 2, and 6 respectively. The absolute difference between CMR1 and CMR2 is 0, the absolute difference between CMR1 and CMR3 is 4, and the absolute difference between CMR2 and CMR3 is 4. Since the absolute difference between CMR1 and CMR2 is less than 3, and the absolute difference between CMR1 and CMR2 is more than 3, and the absolute difference between CMR2 and CMR3 is more than 3, the WTRU may select CMR3 as it has the highest measurement value.

TABLE 2

| | Measured RSRP/SINR | | | | | | |
|---|---|---|---|---|---|---|---|
| | CMR1 | CMR2 | CMR3 | Absolute difference between | | | |
| Selection | High | Medium | Low | [CMR1, | [CMR1, | [CMR2, | N Selected |
| example | priority | priority | priority | CMR2] | CMR3] | CMR3] | CMRs |
| 1 | 1 | 2 | 3 | 1 | 2 | 1 | CMR1, |
| | | | | | | | CMR2 |
| 2 | 2 | 6 | 6 | 4 | 4 | 0 | CMR2, |
| | | | | | | | CMR3 |
| 3 | 2 | 2 | 6 | 0 | 4 | 4 | CMR1, |
| | | | | | | | CMR3 |

The example in Table 2, is based on a gNB configuration that includes M=3 CMRs and N=2 CMRs with an associated high selection priority for CMR 1, a medium selection priority for CMR2 and a low selection priority for CMR3. A selection threshold value or a threshold value of 3 is considered. Three selection examples are depicted in Table 2.

In selection example 1, the measurements (for example, RSRP or SINR) based on CMR1, CMR2, and CMR3 is 1, 2, and 3 respectively. The absolute difference between CMR1 and CMR2 is 1, the absolute difference between CMR1 and CMR3 is 2, and the absolute difference between CMR2 and CMR3 is 1. Since the absolute difference for all the cases is less than 3, so for selection of CMRs, the WTRU follows the priorities of the CMRs. Therefore, the WTRU selects a CMR with the first highest selection priority, which is the first CMR, i.e., CMR1 and a CMR with the second highest selection priority which is the second CMR, i.e., CMR2.

In selection example 2, the measurements (for example, RSRP or SINR) based on CMR1, CMR2, and CMR3 is 2, 6, and 6 respectively. The absolute difference between CMR1 and CMR2 is 4, the absolute difference between CMR1 and CMR3 is 4, and the absolute difference between CMR2 and CMR3 is 0. Since the absolute difference between CMR1 and CMR2 is more than 3, and the absolute difference between CMR1 and CMR3 is also more than 3, therefore the WTRU may select CMR2 and CMR3.

In selection example 3, the measurements (for example, RSRP or SINR) based on CMR1, CMR2, and CMR3 is 2, 2, and 6 respectively. The absolute difference between CMR1 and CMR2 is 0, the absolute difference between CMR1 and CMR3 is 4, and the absolute difference between CMR2 and CMR3 is 4. Since the absolute difference between CMR1 and CMR2 is less than 3, and the absolute difference between CMR1 and CMR2 is more than 3, and the absolute difference between CMR2 and CMR3 is more than 3, the WTRU may select CMR1 and CMR3.

TABLE 3

Measured RSRP/SINR

| | CMR1 | CMR2 | CMR3 | |
|---|---|---|---|---|
| Selection | High | Medium | Low | Selected |
| example | priority | priority | priority | CMRs |
| 1 | 2 | 3 | 4 | CMR1 |
| 2 | 3 | 5 | 4 | CMR2 |
| 3 | 5 | 8 | 10 | CMR3 |

The example in Table 3, is based on a gNB configuration that includes M=3 CMRs and N=1 CMR with an associated selection priority value 1 (high selection priority) for CMR 1, associated selection priority value 0.5 (medium priority) for CMR2 and an associated selection priority value (0) (low priority) for CMR3. A selection threshold value or a threshold value of 5 is considered. Three selection examples are depicted in Table 3.

In selection example 1, the measurements (for example, RSRP or SINR) based on CMR1, CMR2, and CMR3 is 2, 3, and 4 respectively. Since measurement values are all less than 5, the WTRU follows the priorities of the CMRs for selection of CMRs. Therefore, the WTRU selects a CMR with the first highest selection priority, which is the first CMR, i.e., CMR1. Alternatively, if the configured threshold value is 1 and since all the CMRs measurements are greater than 1, the WTRU may select CMR1. Alternatively, if the configured threshold value is 1, and since all the CMRs measurements are greater than 1, the UE may select CMR3.

In selection example 2, the measurements (for example, RSRP or SINR) based on CMR1, CMR2, and CMR3 is 3, 5, and 4 respectively. Since measurement value of CMR2 is higher than the threshold value, the WTRU selects CMR2. Alternatively, if the configured threshold value is 3.5 and since the measurements of CMR2 and CMR3 are greater than 3.5 and CMR2 has a higher selection priority as compared to CMR3, the WTRU may select CMR2.

In selection example 3, the measurements (for example, RSRP or SINR) based on CMR1, CMR2, and CMR3 is 5, 8, and 10 respectively. Since the measurement value of CMR2 and CMR3 is higher than the threshold value, the WTRU selects CMR3.

TABLE 4

Measured RSRP/SINR

| | CMR1 | CMR2 | CMR3 | |
|---|---|---|---|---|
| Selection | High | Medium | Low | Selected |
| example | priority | priority | priority | CMRs |
| 1 | 2 | 3 | 4 | CMR1, CMR2 |
| 2 | 3 | 5 | 4 | CMR1, CMR2 |
| 3 | 5 | 8 | 10 | CMR2, CMR3 |

Table 4 is an example of CMR selection based on N=2 and M=3, where the CMR selection is performed based on the measurements (for example, RSRP or SINR), the selection priority values associated with each CMR and a single selection threshold equal to 5.

In embodiments, when the WTRU needs to select one or more CMRs from a set of CMRs that has (have) the same selection priority values and/or the same associated threshold values and/or the same measurement values, the WTRU may select a CMR based on one or more of the following,
a) The WTRU may select a CMR Based on the index of CMR. For example, CMR1 has a selection priority value equal to 1 and CMR2 has a selection priority value equal to 1. CMR1 and CMR2 both has associated threshold value equal to 2. Measurement value based on both CMR1 and CMR2 is 5. The WTRU needs to select one out of the 2 CMRs. The WTRU may select a CMR with the lowest index, i.e., CMR1. Alternatively, the WTRU may select a CMR with the highest index, i.e., CMR2.
b) The WTRU may select a CMR Based on the time-domain and/or frequency domain location of the CMRs. For example, CMR1 is transmitted at frequency-unit f_1 and CMR2 is transmitted at frequency-unit f_2, and where f_1<f_2. The WTRU selects a CMR based on the frequency location of the CMR, for example, the WTRU selects a CMR at the smallest frequency, i.e., CMR1. Alternatively, the WTRU selects a CMR at the highest frequency, i.e., CMR2. For another example, CMR1 is transmitted at time-unit t_1 and CMR2 is transmitted at time-unit t_2, and where t_1<t_2. The WTRU selects a CMR based on the time location of the CMR, for example, the WTRU selects a CMR at the earliest time, i.e., CMR1. Alternatively, the WTRU selects a CMR at the latest time, i.e., CMR2.

In further embodiments, the WTRU may determine a CSI based on one or more of the selected CMRs.

CMR, CMR-Is, or CMR-BIs grouping are described herein.

Since wireless channels represent different levels of frequency selectivity, it is not always necessary to perform CSI computing and reporting at a high frequency granularity. An independent CSI determination based on each CMR, CMR-Is, or CMR-BIs requires excessive computational power and time-domain and frequency-domain resources for reporting the determined CSI. In CMR Case-B, difference between two Angles of Departures (AoDs) at two subband may not be very high and therefore the two CMR, CMR-Is, or CMR-BIs may be correlated in terms of long-term channel statistics of the channel. Therefore, one or more CMR, CMR-Is, or CMR-BIs may be grouped together and then short-term channel statistics, for example, CMR level CSI for the CMR in the group of CMRs may be determined based on the long-term channel statistics of the group of CMRs.

To determine the required subband size, a WTRU may first estimate a reasonable size for subband size, and then perform CSI computation and reporting, using one or more of the followings,

In embodiments, a WTRU may assume that the AoD corresponding to the beams associated with adjacent frequency resources may not be large, and hence there are a non-negligible correlation between the two frequency resources. Therefore, one or more frequency resources associated to CRBI-s (RBs, subband, etc.) may be grouped together to reduce CSI computation workload and reporting overhead.

In embodiments, a WTRU may perform one or more of the following to determine the correlation among the adjacent frequency resources, using one or more of the following:
a) in embodiments, a WTRU may evaluate spectral correlation function that may be computed as

$$R ( f\_ 1 , f\_ 2 ) = mean \{ X ( f\_ 1 ) X * ( f\_ 2 ) \}$$

where X(f) is the Fourier transform of the CSI-RS signal at frequency f.
b) in embodiments, a WTRU may perform an estimate of coherency in frequency domain by computing, the Magnitude-Squared coherence as,

$$C ( f\_ 1 , f\_ 2 ) = {\vert X ( f\_ 1 , f\_ 2 ) \vert}^{⋀} 2 / ( X ( f\_ 1 ) X ( f\_ 2 ) )$$

where X(f_1,f_2) is the cross-spectral density and X(f) is the measure power spectral density at frequency f.
c) in embodiments, a WTRU may determine the channel delay profile based on frequency resources associated to each subband. Then, based on the measured correlation, for example by,

$$R ( t\_ 1 , t\_ 2 ) = mean \{ h ( t\_ 1 ) h * ( t\_ 2 ) \}$$

where h (t) is the channel impulse response based on CSI-RS resources.

If the measured correlation is less than a configured threshold, a WTRUR may compute, and report CSI based on the determined subband size.

In embodiments, the grouping of the reported coefficients may be based on a minimum correlation threshold between two sub-bands. Two reported correlation sub-bands may have their analog beams defined/configured under the same SSB index.

Upon reporting measurement on configured CMRs for the analog selected beams, the WTRU may measure their spectral correlation. Based on the spectral correlation determination, the WTRU may report the quantization of the determined coefficients on pairs as differential values. The reported CSI may include one or more determined subband size, and the measured correlation value.

Measurement Restrictions and determination of uplink resources for CSI reporting are described herein.

In embodiments, the WTRU may semi-statically or dynamically (for example, by RRC, MAC-CE, and/or DCI) receive one or more indications that indicates measurement restrictions. These may include: CMR-restriction, restricted layers, and restricted SD basis vectors

CMR-restriction: The WTRU receive(s) indication(s) that restrict(s) one or more of the configured CMRs for CSI determination, where the CMRs may be configured based on CMR Case-A or CMR Case-B. For a restricted CMR, the WTRU may not count the active resources, number of CPUs and may drop the CSI request associated with the CMR.

For example, the resource set has M number of CMRs. The WTRU receives a first bitmap that has M bits. Each bit may be associated to one CMR. Bit value 1 in the bitmap may mean that the CMR is restricted and bit value 0 in the bitmap may mean that the CMR is not restricted.

Restricted layers: For each of the non-restricted CMR, the WTRU may receive a second indication that indicates the restricted layers on the non-restricted CMR.

For example, the first bit value in the first bitmap is 0, which means the first CMR is non-restricted. The WTRU may receive a second bitmap that may have v number of bits, where v may be the total number of layers and where each bit value in the bitmap of v bits is associated with a layer index. When the first bit in the second bitmap is 1, it may imply or mean that the first layer associated with the first CMR is restricted. When the fourth bit of the second bitmap is 0, and the second bitmap is associated with the first CMR. It may imply that the fourth layer associated with the first CMR is restricted.

In embodiments, the first bitmap may not be present at all and for each of the CMR, the second bitmap may be present. The WTRU may determine a restricted CMR based on the second bitmap. For example, when all the bits in the second bitmap are 1, that may mean that all the layers associated with the CMR are restricted. Therefore, the CMR is also restricted.

Restricted SD basis vectors: For each of the non-restricted CMR, the WTRU may receive a third indication that indicates the restricted SD basis vector associated with a CMR. For example, the first bit in a first bitmap is 0, that mean that first CMR is not restricted. The third indication is based on a bitmap that has N_1 O_1 N_2 O_2 number of bits and each bit in the third bitmap is associated with a precoder in the codebook of precoders. A bit value 1 in the third bitmap may mean that the precoder is restricted.

Uplink resources determination for CSI reporting are described herein.

The gNB may assign uplink resources to the WTRU for data, CSI reporting, ACK/NACK reporting, and/or scheduling requests etc. WTRU may determine uplink resources for CSI reporting when CSI reporting is based on CMR, the number of frequency-units, time-units, power level, and/or codes, as described here.

The WTRU may determine uplink resources for CSI determination based on the maximum payload size generated by the allowed CMRs, the allowed layers, and/or the allowed SD basis vectors. For example, two CMRs may be configured. The first CMR is restricted and the second is non-restricted. Since the first CMR is restricted, all the layers and SD basis associated with the first CMR are also restricted. The second CMR may have associated 1st, 2nd, and 3rd, layers. The 1st, and 3rd layer associated with the second CMR may also be restricted. The second CMR may have associated 1st, 2nd, 3rd, 4th, 5th, and 6th SD basis vectors or precoders in the codebook of precoders, i.e., N_1 O_1 N_2 O_2 associated with the second CMR is N_1 O_1 N_2O_2=6. The 4th, 5th, and 6th SD basis vector may be restricted. The WTRU may determine the maximum CSI payload size based on the payload size generated by one or more of the following: a) the second CMR; b) the 2nd layer associated with the second CMR; and/or c) the 1st, 2nd and 3rd basis vectors associated with the second CMR.

For example, the WTRU may determine that the maximum CSI payload size is 20 bits. The WTRU determines a number of resources that can fit a payload size equal to 20 bits, for example, based on other configurations like MCS, CQI, etc., and the maximum CSI payload size determined by the WTRU, i.e., 20 bits, the WTRU further determines that s1 number of frequency-units (for example, subcarriers or RB) and/or time-unit(s), for example, symbols are needed for reporting the CSI.

For example, when the WTRU determines the number of resources needed for transmission or reporting of the CSI, it also determines resources that can be used for bit-padding, for example, zero's bit-padding or one's bit-padding, for example, the WTRU determines that the number of determined resources can be used for transmission of 50 bits. The WTRU may add 50−20=30 bits as zero padding bits or one padded bits to achieve a fixed payload size.

Determination and reporting of channel state information are described herein.

In embodiments a WTRU may do one or more of the following for a group of CMR(s). a) the WTRU may determine a rank value (for example, a common rank value) for all CMRs in the group of CMRs; and/or b) the WTRU may determine one or more set(s) of SD basis vectors for a group of CMRs, where at least one of the following may apply: The number of SD basis vector set(s) associated with a group of CMRs is equal to the rank value associated with the group of CMRs; SD basis vectors for a first spatial-layer at one or more CMRs in a group of CMRs is determined from a first set of SD basis vectors, where the number of spatial-layers is equal to the rank value associated with the group of CMRs; and/or SD basis vectors for a second spatial-layer associated with one or more CMRs in the group of CMRs is selected from a subset of the second set of SD basis vectors, where the subset of the second set of SD basis vectors for a CMR in the group of CMRs is determined based on the SD basis vector(s) selected for the first spatial-layer of the CMR.

Antenna panels are discussed herein.

Antenna systems based on cross-polarization are widely used in multi-antenna transmission systems. Cross-polarized architectures support implementation of multi-antenna system in a limited form factor. Further, employment of cross-polarized antennas provides some additional diversity. In a cellular system, Cross-polarized antennas can be used at both gNB and WTRU sides.

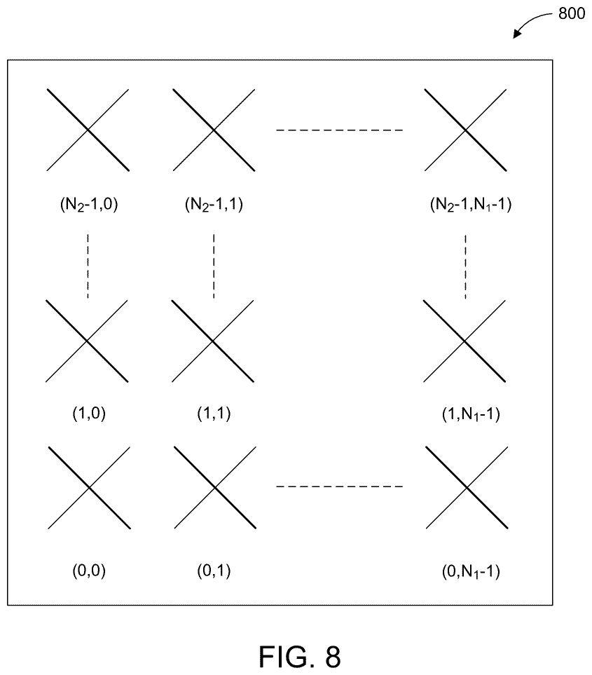

FIG. 8 shows a general architecture of an example antenna-panel 800 based on cross polarized antenna elements, A typical rectangular panel array antenna can be described by the following set of parameters,
Mg, the number of panels in a column,
Ng, the number of panels in a row,
N₂, the number of antenna elements with the same polarization in each column of a panel,
N₁, the number of antenna elements with the same polarization in each row of a panel,
P, the number of polarizations.

For the antenna panel considered in FIG. 8, a codebook of precoders may be designed where a precoder is a combination of phase and amplitude coefficients that can be applied to the 2N₁N₂ antenna ports of FIG. 8. The following example basis functions may be considered or used,

$${u}_{m} = [ \begin{matrix}1 & {e}^{j \frac{2 π m}{{O}_{2} {N}_{2}}} , ⋯ , {e}^{j \frac{2 π m ( {N}_{2} - 1 )}{{O}_{2} {N}_{2}}}\end{matrix} ]$$

$${v}_{l , m} = [ \begin{matrix}{u}_{m} & {e}^{j \frac{2 π l}{{O}_{1} {N}_{1}}} {u}_{m} , ⋯ , {e}^{j \frac{2 π l ( {N}_{1} - 1 )}{{O}_{1} {N}_{1}}} & {u}_{m}\end{matrix} ]$$

Where v_{(l,m)} for a given l and m values is a vector of complex number of length N₁ N₂ and where m=0, . . . ; N₂ O₂−1, I=0, . . . , N₁ O₁−1, O₁ is an oversampling value, for example, a Discrete Fourier transform (DFT) oversampling value and O₂ is also a DFT oversampling value. Based on the above, the codebook of precoder will have N₁ O₁ N₂ O₂ number of v_{(l,m)} values or v_{(l,m)} number of precoder vectors.

In embodiments of cross-polarized antenna-elements based transmissions, the codebook structure in matrix form may be denoted as follows:

$${W}_{1} = [ \begin{matrix}{v}_{l , m} & 0 \\ 0 & ϕ {v}_{l , m}\end{matrix} ]$$

Where v_{(l,m)} is the precoding vector for antenna elements in a first polarization and where φv_{(l,m)} is the precoding vector for antenna elements in a second polarization.

Two step CSI determination and reporting are described herein.

In NR, a given bandwidth W is based on concatenated frequency-units, for example, resource blocks (RBs) or subbands. For example, a given bandwidth W has L=3 number of RBs.

In embodiments regarding CMR Case-A, a reference signal (for example, CSI-RS) may be present in every RB, for example, in each of the L=3 RBs, there can be a CSI-RS and a single beam (for example, an analog beam) is used for transmission of the CSI-RS resources in the L=3 RBs.

In embodiments regarding CMR Case-B, an RB specific beam (for example, analog beam) may be used to generate a beam. In the L=3 RBs, the transmitter may transmit a reference signal in each RB using a different beam. For example, Beam1 may be generated at the first RB and beam1 may transmit CMR1; Beam2 may be generated at the second RB and beam2 may transmit CMR2; and Beam3 may be generated at the third RB and beam3 may transmit CMR3.

Therefore, due to the low CMR density in CMR Case-B, the WTRU may not be able to better estimate the channel or CSI associated with: Second and third RB when using CMR1; First and third RB when using CMR2; and First and second RB when using CMR3

Therefore, embodiments are described herein to determine a CSI based on CMR that do not cover certain portions of a bandwidth.

In embodiments, the WTRU may receive a first set of CMRs based on CMR Case-B, where the first set of CMRs may include one or more CMRs. One or more of the following may apply:
a) One or more CMRs in the first set of CMRs may be based on a first number of antenna-units, for example, one or more CMRs in the first set of CMRs is based on a single antenna port.
b) The WTRU may select a subset of CMRs in the first set of CMRs. For example, the first set includes M number of CMRs and the WTRU selects N=1 CMR out of the M CMRs. For example, the selection is based on the embodiments described herein above. In further embodiments, the selection is based on measurements performed by the WTRU, for example, based on RSRP or SINR.
c) The first CMR may have a reference signal density equal to D1 where a reference signal density may be defined as the number of reference signals, for example, CSI-RS signals in a frequency-unit, for example, in an RB.
d) The WTRU may report the selected CMR indexes to the gNB in a CSI report using uplink transmission, for example, through PUCCH or PUSCH, where the indicators associated with reporting indexes of the CMRs may have a higher selection priority as compared to the remaining contents of a CSI report. A first CSI report that includes indications for indicating the selected CMR indexes may have a higher selection priority over a second CSI report that do not include indications for indicating the selected CMR indexes.

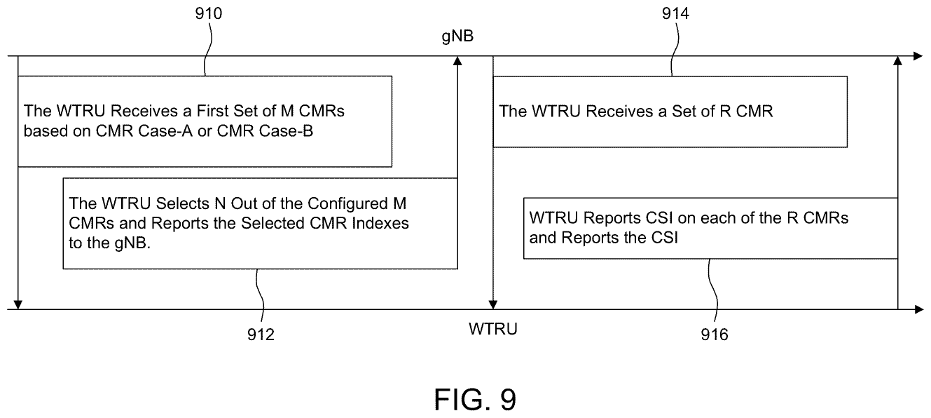

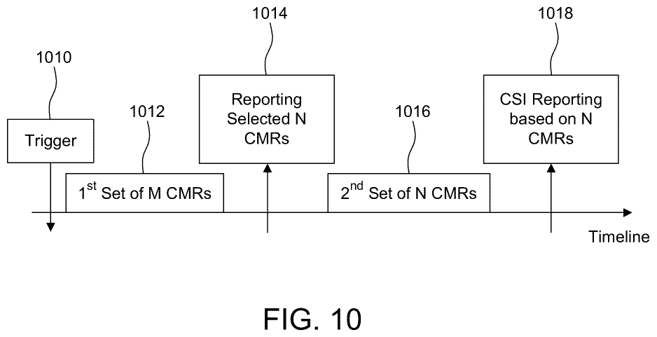

An example of two-step CSI reporting is illustrated in FIG. 9. At 910, the WTRU receives a first set of M MRs based on CMR Case A or CMR Case B. At 912, the WTRU selects N out of the configured M CMRs and reports the selected CMR indexes to the gNB. At 914 the WTRU received a set of R CMRs. At 916 the WTRU reports CSI on each of the R CMRs.

In embodiments, one or more CMRs in the first set of CMRs may be associated to one or more CMRs in a second set of CMRs where the first set of CMRs and the second set of CMRs may be associated in different time locations, for example, in different slots. The association may be based on at least one of the following:

a) Timing relationship: A first CMR in a first set of CMR may be received at time slot n. The first CMR received at time slot n in the first set of CMRs may be associated with a first CMR in a second set of CMRs where the second set of CMRs or the first CMR in the second set of CMRs may be received at time slot n+b. When the WTRU selects and reports a first CMR in a first set of CMRs at time slot n it expects, or it receives a first CMR in a second set of CMRs at time slot n+b.

b) Frequency relationship: A first CMR in a first set of CMR may be received at frequency-unit f_1 of time t_1. The first CMR received at f_1 of time t_1 may be associated with a first CMR in a second set of CMRs where the second set of CMRs or the first CMR in the second set of CMRs may be received at frequency f_1 and frequency f_2 at time t_2. When the WTRU selects and reports a first CMR associated with f_1 at time t_1 in a first set of CMRs, the WTRU expects to receive a first CMR at frequency f_1 and f_2 at time t_2 in a second set of CMRs.

c) Relationship based on number of ports: A first CMR in a first set of CMR may be based on a first number of CMR ports. The CMR with a first number of CMR ports in the first set of CMRs may be associated with a CMR in a second set of CMR that is based on a second number of CMR ports. For example, a CMR1 in set1 is 2 ports and CMR2 in set2 is 64 ports. When the WTRU selects CMR1 in set1, it expects to receive CMR2 in set2.

Upon reporting the selected CMR indexes, the WTRU may receive an acknowledgement from the gNB. For example, the WTRU reports the selected CMR indexes at time slot n. The WTRU expects to receive an ACK or NACK at time slot n+m. For example, at a first frequency-unit of the first time symbol at time slot n+m, the WTRU performs blind decoding or non-blind decoding for receiving an ACK or NACK.

In embodiments, the WTRU may receive a second set of CMRs that has a time and/or frequency relationship to one or more CMRs in the first set of CMRs and where the second set of CMR may include one or more CMRs. The first CMR in the second set of CMRs that is related to the first CMR in a first set of CMRs may satisfy at least one of the following: a) The first CMR in the second set of CMRs may be based on a larger number of antenna-elements or antenna ports as compared to the first CMR in the first set of CMRs; and/or b) The first CMR in the second set of CMRs may have higher CMR, for example, CSI-RS density as compared to the CSI-RS density of the first CMR in the first set of CMRs.

In embodiments, the WTRU may semi-statically or dynamically (for example, by RRC, MAC-CE, and/or DCI) receive one or more configurations and/or indications that triggers or configures the second set of CMRs for determination of CSI. The second set of CMRs may be configured based on the N selected CMRs.

In embodiments, the WTRU may receive the one or more CMRs in the second set of CMR and may determine a CSI based on one or more of the received CMRs, for example: a) a single CSI based on each received CMR—for example, 2 CMRs each 32 antenna ports is received by the WTRU. The WTRU determines a first CSI and a second CSI where each CSI is based on 32 antenna ports. b) a single CSI based on all received CMRs—for example, 2 CMRs each 32 antenna ports is received by the WTRU. The WTRU determines a 64 antenna ports CSI. For another example, 2 CMRs each 32 antenna ports is received by the WTRU. The first CMR is from a first panel and the second CMR is from a second panel. The WTRU determine a 2-panel CSI.

The timeline associated with the two step CSI determination and reporting is depicted for example in FIG. 10. At 1010, the WTRU first receives a trigger, for example, based on RRC, MAC-CE, and/or DCI that triggers the CMRs in the first (1st) set of CMRs 1012 and/or the CMRs in the (2nd) set of CMRs 1016. The trigger includes indications for the time window associated with the first set of M CMRs, for example, the starting and ending time-units and/or frequency-units for one or more (for example, for each) of the M CMRs in the first set of CMRs, resources for reporting the selected N CMRs at 1016. CSI reporting is shown at 1018.

In embodiments, a WTRU may have a capability of supporting a maximum number of active resources. A WTRU may be configured with M CMRs in a first set of CMRs. The WTRU may be configured to select N out of M CMRs from the first set of CMRs. The WTRU may count the configured M CMRs in the first set of CMRs and N CMRs in the second set of CMRs as the total number of active CMRs in an active window.

For example, the total number of active CMRs in the active window may be M+N CMRs.

For example, the total number of active CMRs in the active window associated with the 1st set of CMRs is M.

For example, the total number of active CMRs in the active window associated with the 2nd set of CMRs is N.

In embodiments, the WTRU may have two capabilities, for example: The first capability of the WTRU may be the number of simultaneous CMRs that it may process for selection of the CMRs. The second capability of the WTRU may be the number of simultaneous CMRs that it may process for determination of CSI.

The WTRU may have a total number of CPUs. The WTRU may use one or more number of CPUs in an active window to a) perform measurements for selection of the N CMRs and/or b) determine CSI based on the selected N number of CMRs. For example, an active window may have one or more sub-windows, for example, the active window has two sub-windows. In the first sub-window of the active window, the WTRU uses a first number of CPUs for selection of the N CMRs and in the second sub-active window, the WTRU uses a second number of CPUs for determination of CSI(s) based on the N selected CMRs.

In embodiments, a CSI request may have an associated active window. The WTRU may have a counter that keeps a count of the number of simultaneous active CMR resources, that it may be capable of processing in an active window. In the two-step CSI reporting, different types of active windows may be defined, for example, summarized as follows:
a) In embodiments there is a single active window, where the active window is associated with the first set of CMRs and the second set of CMRs. In embodiments, the active window may start from the last time-unit of the trigger that triggers the CSI report. In embodiments, the active window may start from the first time-unit of the first CMR in the first set of CMRs. In embodiments, the active window may end at the last time-unit of the first or last time-unit where the CSI is being reported.
b) In embodiments, there are two active windows or a single active window with two sub-windows may be defined, where the first active window or the first sub-window may be associated with a first set of CMR and the second active window or the second sub-window may be associated with the second set of CMR.

Criteria for CSI determination are described herein.

In 5G NR, the gNB configures the CMRs. The WTRU receives the CMRs and makes an estimate (for example H) of the actual (for example, H⁻) MIMO wireless channel based on the received CMRs. Based on H⁻ the WTRU may solve some optimization problems or an optimization problem to derive report quantities that represents or reflects the behavior or condition of the wireless channel. Particularly, the WTRU may determine report quantities or CSI by solving an optimization problem that involves the determined channel matrix H. For example, the WTRU determines a precoder Wᵢ, i∈{1, . . . , N₁ O₁ N₂ O₂} from a codebook of precoders that has N₁ O₁ N₂ O₂ number of precoders by solving the following optimization problem that maximizes the channel capacity, i.e., Maximize (Cᵢ; Wᵢ), for all i, where Cᵢ is the Shannon capacity, for example, Cᵢ=log₂ (1+HWᵢ) of a hypothetical downlink transmission when applying the precoder Wᵢ at the transmitter. In general, the WTRU algorithm determines a precoder that maximizes a channel quality indicator (CQI) value under a BLER constraint.

In embodiments, due to multiple reasons for example, MU-MIMO or throughput, or interference mitigation, the NW may be interested in a specific type of CSI that is determined by maximizing or minimizing a certain function. Therefore, the gNB may configure such rules or optimization to the WTRU for CSI determination.

In embodiments, a CSI request may have associated indications (for example, through RRC, MAC-CE, and/or DCI) that indicates a CSI determination criteria.

For example, the WTRU receives a DCI that includes a field that indicates the index of an RRC configured CMR and triggers the CMR for CSI determination. The DCI also include another field that is associated with the field triggering the CSI determination criteria for the CSI request.

The CSI determination criteria may be based on one or more of the following criteria,

Criteria 1: The WTRU may be configured to select a precoder that supports the highest number of layers that may be possible,

For example, the rank of the channel matrix is 6. The WTRU determines a precoder that supports 6 number of layers.

Criteria 2: The gNB configures a rank threshold. The WTRU determines a precoder that can support a number of layers, less than or equal to the configured rank threshold.

For example, the gNB configures a rank value equal to 4. The WTRU determines a precoder that can support 4 or more number of layers, or alternatively a precoder that can support 4 or less number of layers.

Criteria 3: The WTRU may select a precoder that minimize the interference.

Criteria 4: The WTRU may select a precoder that maximizes a CQI

Criteria 5: The WTRU may select a precoder that jointly maximizes CQI, minimize interference and increase the number of layers.

Precoder determination is described herein.

In CMR Case-B or in CMR Case-A, CSI determination for every CMR or CSI determination based on every CMR or every selected CMR requires a large amount (for example, depends on the number of CMRs and/or the selected number of CMRs) computational resources, for example, number of CPUs. CSI associated with multiple CMR, CMR-Is, or CMR-BIs demands a lot of overhead a well. As described herein, two or more CMRs, CMR-Is, or CMR-BIs may be correlated. Therefore, the computational complexity and the feedback overhead can be significantly reduced when a CSI is determined for a group of CMR, CMR-Is, or CMR-BIs. Hereinafter, a PMI may be interchangeably used with indexes of one or more SD basis vector, where the index of an SD basis vector in a codebook of SD basis vectors in identified by and i_{(1,2)}.

In embodiments, a WTRU may determine a common rank value for all CMRs in the group of CMRs or the WTRU may determine a CMR specific rank value. For example, the WTRU may determine a CMR-common rank value, for example, a common rank indicator for all CMRs. In embodiments, the WTRU may determine a CMR-specific rank value, for example, a specific rank indicator for each CMRs in the selected CMRs.

In embodiments, the WTRU may determine a precoder (for example, a group precoder matrix indicator (PMI)) based on the selected CMRs, CMR-Is, or CMR-BIs. For example, the group PMI may be expressed as,

$${v}_{l + {l}^{′} , m + {m}^{′}}$$

Where l∈{0, . . . , N₁O₁−1}, m∈{0, . . . , N₂O₂−1} and where l′ is a set of values or index value(s) in the range 0, . . . , N₁ O₁−1 and m′ is a set of values or index value(s) in the range 0, . . . , N₂ O₂−1.

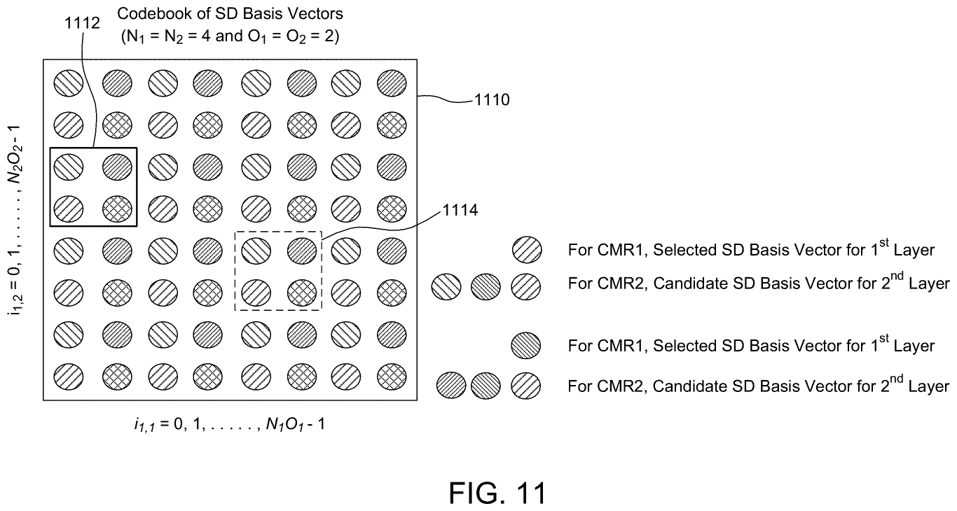

For example, v_{i+l′m+m′} indicates a set of SD basis vectors. For example for N₁=N₂=4 and O₁=O₂=2 when l=0 and m=4 and when l′={0,1} and when m′={0, 1}, the set of SD basis indicated by, v_{i+l′m+m′} is as depicted in FIG. 11, 1112, which is the first set of SD basis vectors for 1^{st} layers associated with all CMRs.

For example, l may be reported as the value of i_{1,1} and m be reported as the value of i_{1,2}.

For example, as a common PMI, the WTRU may select or determine oversampling indexes, for example, q₁ ∈{0, . . . , O₁} and q₂ ∈{0, . . . , O₂}. Based on the determined oversampling indexes the WTRU may determine a subset of SD basis vector associated with the selected (q₁,q₂) values. For example, for any (q₁,q₂) selected values, there exists N₁ N₂ number of SD basis vectors that are orthogonal to each other in both dimension. For example, for any (q₁,q₂) values, there exists Xa number of SD basis vectors that are orthogonal to an SD basis vector in the N₁ N₂ SD basis vectors in at least one dimension.

In embodiments, the WTRU may determine a plurality of group PMIs, where the number of group PMIs depends on the CMR-common rank value. For example, the CMR-common rank value is 4. The number of group PMIs that the WTRU determines is equal to 4, i.e., for each transmission layer across all CMRs, the WTRU determines a group PMI.

In embodiments, the group PMIs may create a common PMI. For example, all the group PMIs may collectively be called or known as a common PMI. Or, for example, for a CMR-common rank value equal to 2, two group PMIs are illustrated in FIG. 11, 1112, 1114 which includes two group PMI, i.e., one for a first layer associated with all CMRs 1112 and another for a second layer associated with all CMR 1114.

In embodiments, for a given layer, the WTRU may determine a PMI based on the group PMI associated with the layer in the common PMI. For example, the CMR-common rank value is 2. The common PMI has two group PMIs, where each group PMI has 4 SD basis vectors as illustrated in FIG. 11.

CMR-level PMI selection: In an embodiment, the WTRU may determine a PMI for one or more CMRs from the common-PMI. First, the WTRU determines a reference CMR based on the RSRP or SINR values associated with the CMRs, or the CMR index, or a CMR index indicated by the gNB. For example,

There are a total of 3 CMR and CMR1 is the reference CMR.

The common rank value is 2. The common PMI has 2 group PMIs.

Based on layer1 associated with CMR1, the WTRU determines the first group PMI and based on layer 2 of CMR2, the WTRU determines a second group PMI. For:

Layer1 associated with CMR1, the WTRU selects an SD basis vector from group 1 PMI.

Layer1 associated with CMR2 and for layer 1 associated with CMR3, the WTRU determines a candidate set of SD basis vectors from group1 PMI that are orthogonal to the SD basis vector selected for Layer 1 associated with CMR1, in at least one dimension.

Layer2 associated with CMR1, the WTRU selects an SD basis vector from group2 PMI.

Layer2 associated with CMR2 and for layer 2 associated with CMR3, the WTRU determines a candidate set of SD basis vectors from group2 PMI that are orthogonal to the SD basis vector selected for Layer 2 associated with CMR1, in at least one dimension.

In embodiments, the WTRU may determine a CQI for each CMR where the CQI may be conditioned on one or more of the following: a) the PMI determined for the CMR; b) the group PMI associated with the CMR and/or c) the common PMI associated with the CMR.

In embodiments, the WTRU may determine LI for each CMR where the LI may be conditioned on one or more of the following: a) the CQI determined for the CMR; b) the PMI determined for the CMR; c) the group PMI associated with the CMR and/or d) the common PMI associated with the CMR.

In embodiments, the WTRU may send a CSI report to the gNB that may include indications to indicate one or more of the following, a) a determined LI for each CMR; b) a determined CQI for each CMR; c) determined PMI for each CMR; d) a determined group PMI associated with each layer; and/or e) a determined common PMI associated with all layer.

Priority rules for determination and reporting of CSI are described herein.

As referred to herein, a CSI priority may be a numerical value, for example, 0 or 1. A smaller value may mean or imply a higher reporting priority and a larger value may mean or imply a smaller reporting priority. Alternatively, a higher value may mean or imply a higher reporting priority and a smaller value may mean or imply a smaller reporting priority.

For example, if two CSI reports, i.e., CSI report 1 and CSI report 2 where CSI report 1 has priority 1 and CSI report 2 has priority 2, implies that the WTRU will prioritize processing and reporting CSI report 1 over CSI report 2.

For example, if two CSI contents in a single CSI report, i.e., CQI and PMI where CQI has priority 1 and PMI has priority 2, implies that the WTRU will prioritize processing and reporting CQI or PMI for the CSI report.

A first CMR, CMR-I, CMR-BI (for example, an analog beam during initial beam selection) in the first set of CMRs has a selection priority value and/or a second CMR, CMR-I, CMR-BI (for example, the analog beam used for CSI determination) in the second set of CMRs has a CSI priority value. For example: A first CMR, CMR-I or CMR-BI has a selection priority value equal to 5. A first CMR, CMR-I, CMR-BI has a CSI priority value equal to 10.

In embodiments, the CSI reporting priority of a CMR, CMR-I, or CMR-BI may be determined based on the selection priority of the associated CMR, CMR-I, or CMR-BI.

When the WTRU determine CSIs (for example, CSI based on one or more CMRs) and it may assign priorities to the determined CSI contents (for example, contents within a single CSI report such as PMI or CQI) and the determined CSI reports (for example, a first CSI report and a second CSI report). The priorities are as follows.

As described herein, different beams or subbands may be grouped together. The gNB configures a selection priority value for each CMR, CMR-I, or CMR-BI, after grouping, the priority of the group becomes the sum of the selection priorities of the CMRs in the group.

For example, CMR1 has a selection priority value equal to 5 and CMR2 has a selection priority value equal to 10 and both are grouped together. The selection priority value of the group becomes 5+10=15.

For example, a CQI determined based on CMR1 has a CSI priority value equal to 2 and PMI determined based on CMR2 has a CSI priority value equal to 3. A CQI determined based on CMR2 has a CSI priority value equal to 2 and PMI determined based on CMR2 has a CSI priority value equal to 3. In embodiments, CSI priority values to the CSI contents associated with a beam may be assigned based on the existing priority rule in the specs. But may be updated based on the selection priorities of the CMRs as follows,

The CSI priority of the CQI and PMI determined based on CMR1 becomes 2+5 and 3+5, for example, the priority equation in the specs is updated to add the associated CMR selection priority values to it.

The CSI priority of the CQI and PMI determined based on CMR2 becomes 10+5 and 10±3, for example, the CSI priority equation in the specs is updated to add the CMR selection priority to it.

When two CSI reports are in contention (for example, the two reports overlap in at least one resource (for example, time or frequency-unit), the contention is resolved using the selection priorities and the CSI priorities. For example,

A CMR (or a group of CMR) has associated determined CSI (or associated determined CSIs). The CSI (or the CSIs) are reported in a single CSI report or in multiple CSI reports, for example: CSI report 1 contains the CQI and PMI determined based on CMR1. CSI report 2 contains the CQI and PMI determined based on CMR2. CSI report 3 contains the CQI and PMI determined based on CMR1 and CMR2.

Assume that the three CSI reports are in contention. Resolution of the contention is based on the priority values, where the priorities are determined based on the following example rule.

Priority value of CSI report 1 equals, 2+5+3+5=15

Priority value of CSI report 2 equals, 2+10+3+10=25

Priority value of CSI report 3 equals, 2+5+3+5+2+10+3+10=40

Based on definitions:
for example, smaller priority values mean higher priority, then CSI report 1 will be prioritized over CSI report 2 and CSI report 3, and CSI report 2 will be prioritized over CSI report 3.
for example, larger priority values mean higher priority, then CSI report 3 will be prioritized over CSI report 1 and CSI report 2, and CSI report 2 will be prioritized over CSI report 1.

In embodiments, when different CMRs, CMR-Is, or CMR-BIs are grouped together, the gNB may configure a new priority value for each beam or subband, after grouping, the priority value to a group may be assigned based on one or more of the following:
a) Based on the number of CMRs in a group of CMR. For example, the group associated with higher number of CMRs, may be assigned a higher CSI report priority value and a group with a smaller number of CMRs may be a smaller CSI priority.
b) Based on the number of CMRs and the number of transmission layers in each CMR and the total number of transmission layers across all CMRs. For example, a first group may have 8 CMRs with only 1 layer while a second group may have 4 CMRs with 4 layers. Thus, the second group may be assigned a higher CSI report priority value than the first group. A WTRU may be configured with two thresholds, one for the number of CMRs in a group, for Example,

$${N}_{CMR}^{th}$$

and another for a number of transmission layer

$${N}_{Layer}^{th} .$$

Any groups with a number of layers

$$layer > {N}_{Layer}^{th}$$

may receive higher priority and then, if more than one group is selected using this approach, the groups may be prioritized based on number of CMRs in the group, i.e., the groups with higher CMRs may be assigned a higher priority. For example, if three groups meet this condition and Group 1, Group 2, and Group 3 have 4 RBs, 8RBs and 16 RBs, respectively. Then, Group 3 has higher priority than Groups 1 and 2. Group 2 has higher priority than Group 1. If two or more groups have the same CMRs, then the groups may be prioritized based on the group index and/or other parameters such as CQI of the group.

The groups with no. of

$$CMR > {N}_{RB}^{th}$$

may receive nigner priority and then, if more than one group is selected with this threshold, the groups may be prioritized based on number transmission layers, i.e., the groups with higher CMRs receive higher priority.

For example, if three groups meet this condition and Group 1, Group 2, and Group 3 have 1 layer, 2 layers and 4 layers, respectively. Then, Group 3 has higher priority than Groups 1 and 2. Group 2 has higher priority than Group 1.

If two or more groups have the same transmission layer, then the groups may be prioritized based on the group index or other parameters such as CQI of the groups.

In embodiments, the priority values to the CSI contents associated with a CMR may be assigned based on CQI and rank (R) associated with the group.

A WTRU may be configured with a threshold based on CQI threshold, CQIₜₕ and rank (R) threshold Rₜₕ, and PMI threshold PMIₜₕ.

If CQI>CQIₜₕ and R>Rₜₕ, and PMI>PMIₜₕ then, those CQI and Rank and PMI may receive higher CSI report priorities.

If there are more than one group that meet these conditions, then WTRU may prioritize the CQI, R, and PMI based on the group indexes

In embodiments, the priority to a subband may be assigned based on the number of subbands and channel characteristic of each subband. Let N_{sub} be the total number of subband configured by RRC/DCI. If the channel is frequency selective and varies slowly over each subbands, the WTRU may be prioritized with the sub-band report over the even or odd sub-bands, i.e., the even sub-bands may have higher priority than odd sub-bands or vice-versa (The reason is that when the channel slowly varies over the frequency, two subbands that are next to each other may have the same channel approximately and gNB may extract the second channel from the first one). In another example, a WTRU may be configured with another threshold

$${N}_{sub}^{th}$$

so that the sub-bands may be prioritized over

$${N}_{sub}^{th}$$

subbands, for example, let

$${N}_{sub}^{th} = 2$$

the first sub-band has the highest priority and the next

$${N}_{sub}^{th} = 2$$

subbands, i.e., the 4th sub-band receives the next priority.

Scheduling based on frequency resources associated with CMRs for downlink receptions is described herein.

In embodiments, a WTRU may receive configuration(s) for one or more codewords (CW)-to-layer mapping rules applicable for more than one subband (SB), for example, when the WTRU receives an enabling signal or configuration for subband-dependent downlink receptions, based on a multiple-subband based DL Tx scheme. In an example, the WTRU may receive a scheduling grant for a PDSCH (for example, scheduled by a DCI as dynamic-grant PDSCH, scheduled by high-layer signaling such as semi-persistent-scheduling (SPS)-PDSCH, etc.), where the scheduling grant may comprise one or more parameters indicating a frequency-domain resource assignment (for example, FDRA) for the PDSCH may be based on more than one subband, each applied with a different (analog) beam. The PDSCH resource may be based on a first SB (corresponding to a first beam) and a second SB (corresponding to a second beam) as an example.

The WTRU may determine, for example, based on the scheduling grant including an indicated DMRS-related information, that a first layer on the first SB may be mapped to CW0 and a second layer on the second SB may be mapped to CW1. Based on the determination, the WTRU may receive the scheduled PDSCH based on the indicated CW-to-layer mapping where the DL data received on the first SB comprises CW0 and the first layer and that received on the second SB comprises CW1 and the second layer.

In embodiments, the WTRU may determine, for example, based on the scheduling grant including an indicated DMRS-related information, that a first layer on the first SB may be mapped to CW1 and a second layer on the second SB may be mapped to CW0, for example, swapped CWs applied on SBs. Based on the determination, the WTRU may receive the scheduled PDSCH based on the indicated CW-to-layer mapping where the DL data received on the first SB comprises CW1 and the first layer and that received on the second SB comprises CW0 and the second layer. This may provide benefits in terms of diversity gain over the frequency-domain and improving the network's scheduling flexibility.

In embodiments, the WTRU may receive configuration(s) with a threshold value, for example, a rank or a CQI-threshold value which may be used for subband-dependent downlink receptions, for example, when a multiple-subband based DL Tx scheme is used.

The WTRU may receive a scheduling grant for a PDSCH (for example, scheduled by a DCI as dynamic-grant PDSCH, scheduled by high-layer signaling such as semi-persistent-scheduling (SPS)-PDSCH, etc.), where the scheduling grant may comprise one or more parameters indicating a frequency-domain resource assignment (for example, FDRA) for the PDSCH may be based on more than one subband, each applied with a different (analog) beam. The PDSCH resource may be based on a first SB (corresponding to a first beam) and a second SB (corresponding to a second beam) as an example.

In an example, the WTRU may determine a SB that has an associated rank value or a rank offset value being less than or equal to the threshold rank. Based on the determination, despite the indicated frequency-domain resource assignment (for example, based on the state value of the bit in the FDRA bitmap), the WTRU may determine (for example, assume) that the SB is not being valid for the PDSCH reception (for example, interpreted as not being assigned to the WTRU). In an example, the WTRU may determine the second SB where the associated rank value or rank offset value is less than or equal to the threshold rank. Based on the determination, despite the indicated frequency-domain resource assignment, the WTRU may determine that the second SB is not being valid for the PDSCH reception, and may receive the PDSCH based on the first SB (for example, only) or receive the PDSCH based on applying at least one parameter for prioritization to the first SB. In an example, receiving the PDSCH based on applying at least one parameter for prioritization to the first SB may imply that the WTRU receives the PDSCH as scheduled by the indicated frequency-domain resource assignment but based on at least one of using the first beam (as a fallback beam) for the PDSCH reception, and/or applying a CW-to-layer mapping rule applicable for the first SB also to the second SB, etc.

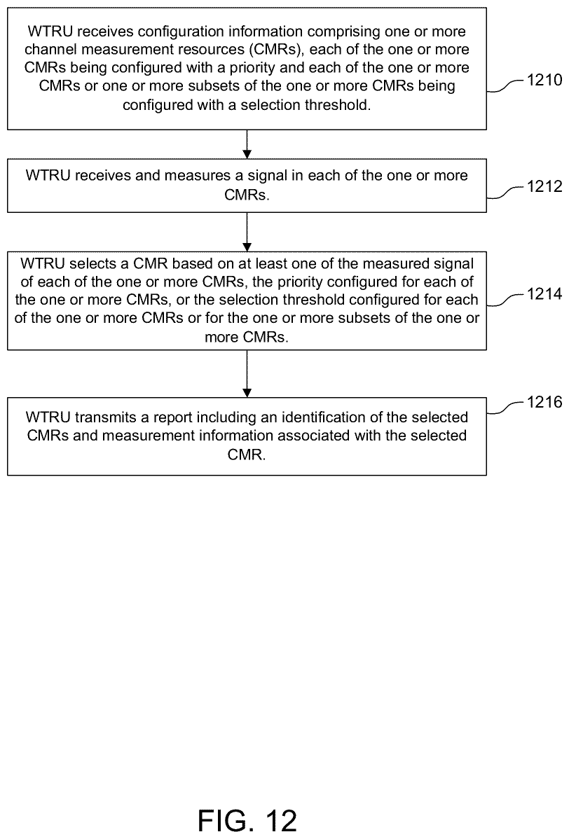

FIG. 12 is a flow diagram of an example process according to embodiments described herein. At 1210, a WTRU receives configuration information comprising one or more channel measurement resources (CMRs), each of the one or more CMRs being configured with a priority and each of the one or more CMRs or one or more subsets of the one or more CMRs being configured with a selection threshold. At 1212, the WTRU receives and measures a signal in each of the one or more CMRs. At 1214, the WTRU selects a CMR based on at least one of the measured signal of each of the one or more CMRs, the priority configured for each of the one or more CMRs, or the selection threshold configured for each of the one or more CMRs or for the one or more subsets of the one or more CMRs. At 1216, the WTRU transmits a report including an identification of the selected CMR and measurement information associated with the selected CMR.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a first wireless transmit/receive unit (WTRU) comprising:
receiving configuration information comprising one or more channel measurement resources (CMRs), each of the one or more CMRs being configured with a priority and each of the one or more CMRs or one or more subsets of the one or more CMRs being configured with a selection threshold;
receiving and measuring a signal in each of the one or more CMRs;
selecting a CMR based on at least one of the measured signal of each of the one or more CMRs, the priority configured for each of the one or more CMRs, or the selection threshold configured for each of the one or more CMRs or for the one or more subsets of the one or more CMRs; and
transmitting a report including an identification of the selected CMR and measurement information associated with the selected CMR.

2. The method of claim 1, wherein the one or more CMRs are one or more channel-state-information reference signal (CSI-RS) resources.

3. The method of claim 1, wherein the measurement information is at least one of CSI, a channel quality indicator (CQI), a rank indicator (RI), a precoding matrix indicator (PMI) or reference signal received power (RSRP).

4. The method of claim 1, further comprising creating groups of the one or more CMRs based on frequency domain correlation or spatial correlation between the one or more CMRs.

5. The method of claim 4, further comprising determining a common CSI for a group of CMRs from the groups of the one or more CMRs.

6. The method of claim 5, further comprising determining a CSI for each CMR in the group of CMRs based on the common CSI.

7. The method of claim 1, wherein each of the one or more CMRs is configured with multiple non-overlapping subbands (SBs).

8. The method of claim 7, wherein each of the multiple non-overlapping SBs is configured with a different spatial filter/beamformer/precoder.

9. The method of claim 7, wherein each of the one or more CMRs is configured with all or a subset of SBs from a bandwidth part (BWP).

10. The method of claim 1 wherein each of the one or more subsets of the one or more CMRs comprises multiple CMRs wherein each CMR in the one or more subsets of the one or more CMRs is associated with one or more SBs.

11. A WTRU comprising:
a processor and
a transceiver,
the processor and transceiver configured to:
receive configuration information comprising one or more channel measurement resources (CMRs), each of the one or more CMRs being configured with a priority and each of the one or more CMRs or one or more subsets of the one or more CMRs being configured with a selection threshold;
receive and measure a signal in each of the one or more CMRs;
select a CMR based on at least one of the measured signal of each of the one or more CMRs, the priority configured for each of the one or more CMRs, or the selection threshold configured for each of the one or more CMRs or for the one or more subsets of the one or more CMRs; and
transmit a report including an identification of the selected CMR and measurement information associated with the selected CMR.

12. The WTRU of claim 11, wherein the one or more CMRs are one or more channel-state-information reference signal (CSI-RS) resources.

13. The WTRU of claim 11, wherein the measurement information is at least one of CSI, a channel quality indicator (CQI), a rank indicator (RI), a precoding matrix indicator (PMI) or reference signal received power (RSRP).

14. The WTRU of claim 11, wherein the processor is further configured to create groups of the one or more CMRs based on frequency domain correlation or spatial correlation between the one or more CMRs.

15. The WTRU of claim 14, wherein the processor is further configured to determine a common CSI for a group of CMRs from the groups of the one or more CMRs.

16. The WTRU of claim 15, wherein the processor is further configured to determine a CSI for each CMR in the group of CMRs based on the common CSI.

17. The WTRU of claim 11, wherein each of the one or more CMRs is configured with multiple non-overlapping subbands (SBs).

18. The WTRU of claim 17, wherein each of the multiple non-overlapping SBs is configured with a different spatial filter/beamformer/precoder.

19. The WTRU of claim 17, wherein each of the one or more CMRs is configured with all or a subset of SBs from a bandwidth part (BWP).

20. The WTRU of claim 1 wherein each of the one or more subsets of the one or more CMRs comprises multiple CMRs wherein each CMR in the one or more subsets of the one or more CMRs is associated with one or more SBs.
